(19) United States
(12) Patent Application Publication
(10) Pub. No.: US 2020/0412718 A1
(43) Pub. Date: Dec. 31, 2020

(54) MONITORING AND CONTROL SYSTEM

(71) Applicant: Mitsubishi Electric Corporation, Chiyoda-ku, Tokyo (JP)

(72) Inventors: Yashiro KOBAYASHI, Tokyo (JP); Hajime SHIOTA, Tokyo (JP)

(73) Assignee: Mitsubishi Electric Corporation, Chiyoda-ku, Tokyo (JP)

(21) Appl. No.: 16/980,989

(22) PCT Filed: Mar. 20, 2018
(86) PCT No.: PCT/JP2018/011128

§ 371 Date: Sep. 15, 2020

(51) Int. Cl. H04L 29/06; H04B 1/02; H04B 1/06; H04L 9/32

(52) U.S. Cl. CPC H04L 63/0876; H04B 1/02; H04L 9/32; H04L 69/22; H04B 1/06

(57) ABSTRACT

A monitoring and control system includes a slave station, a master station, and a monitoring and control device. The master station includes a transmission unit that transmits second control data including authentication data and second data to the slave station. The transmission unit transmits, to the slave station, the second control data including the authentication data stored in an area in a payload defined to store the second data. An authentication unit of the slave station determines whether data included in the area in the payload of the second control data matches authentication data stored in a memory unit. A transmission unit of the slave station transmits the second data included in the second control data to the device(s) if the authentication unit determines that the data included in the area in the payload matches the authentication data stored in the memory unit.

### FIELD

The present invention relates to a monitoring and control system that monitors and controls multiple devices.

### BACKGROUND

A monitoring and control system includes a slave station that collects data from each of multiple devices, a master station, and a monitoring and control device that collects data from the slave station via the master station and transmits data for controlling the devices to the slave station via the master station.

The above data handled in such a monitoring and control system is transmitted and received via a network. There is a threat in a network such as information tampering and spoofing. In particular, tampering with or spoofing of data for controlling a device may allow unauthorized control of the device.

A technology of authentication is known as a technology for preventing such unauthorized control. For example, Patent Literature 1 suggests an authentication technology in which authentication data is carried in the header of each of data packets transmitted and received between devices to determine the validity of the data packets.

### CITATION LIST

### Patent Literature

Patent Literature 1: Japanese Patent Application Laid-open No. 2012-34169

### SUMMARY

### Technical Problem

However, to apply the authentication technology described in Patent Literature 1 to a monitoring and control system, the format of data packets transmitted and received between devices needs to be modified. Accordingly, application of such authentication technology to a monitoring and control system in service will require changing of the communication interface in use to a communication interface that permits authentication data to be carried in the data packet header. This will have a large effect on the system configuration of the monitoring and control system.

The present invention has been made in view of the foregoing, and it is an object of the present invention to provide a monitoring and control system capable of reducing or eliminating the effect on the system configuration and also of preventing unauthorized control.

### Solution to Problem

To solve the problem and achieve the object described above, a monitoring and control system according to an aspect of the present invention includes a slave station to obtain first data from each of a plurality of devices, a master station, and a monitoring and control device to collect the first data from the slave station via the master station and to transmit second data for controlling the devices to the slave station via the master station. The master station includes a first memory unit to store authentication data, a first reception unit to receive first control data including the second data from the monitoring and control device, and a first transmission unit to transmit, to the slave station, second control data including the authentication data stored in the first memory unit and the second data. The first transmission unit transmits, to the slave station, the second control data including the authentication data stored in an area in a payload defined to store the second data. The slave station includes a second memory unit to store authentication data, a second reception unit to receive the second control data from the master station, an authentication unit to determine whether data included in the area in the payload of the second control data received by the second reception unit matches the authentication data stored in the second memory unit, and a second transmission unit to, if the authentication unit determines that the data included in the area in the payload matches the authentication data stored in the second memory unit, transmit the second data included in the second control data to at least one of the devices.

### Advantageous Effects of Invention

The present invention provides an advantage in being capable of reducing or eliminating the effect on the system configuration and also of preventing unauthorized control.

### BRIEF DESCRIPTION OF DRAWINGS

FIG. 1 is a diagram illustrating an example configuration of a monitoring and control system according to a first embodiment of the present invention.

FIG. 2 is a diagram for describing processing of setting of second data in devices by the monitoring and control system according to the first embodiment.

FIG. 3 is a diagram illustrating an example of format of a data packet transmitted from a master station to a slave station according to the first embodiment.

FIG. 4 is a diagram illustrating an example configuration of the monitoring and control device according to the first embodiment.

FIG. 5 is a diagram illustrating an example of device management table according to the first embodiment.

FIG. 6 is a diagram illustrating an example of first format, which is the format of data packets transmitted and received between the monitoring and control device and the master station according to the first embodiment.

FIG. 7 is a diagram illustrating an example configuration of the master station according to the first embodiment.

FIG. 8 is a diagram illustrating an example of second format, which is the format of data packets transmitted and received between the slave station and the master station according to the first embodiment.

FIG. 9 is a diagram illustrating an example of slave station list according to the first embodiment.

FIG. 10 is a diagram illustrating an example of area assignment table according to the first embodiment.

FIG. 11 is a diagram illustrating an example structure of first collection data transmitted from the slave station to the master station when the operation mode of each of the slave station and the master station is set to non-dummy setting mode, according to the first embodiment.

FIG. 12 is a diagram illustrating an example configuration of the slave station according to the first embodiment.

FIG. 13 is a diagram illustrating an example of area assignment table according to the first embodiment.

FIG. 14 is a flowchart illustrating an example of data collection process of the slave station according to the first embodiment.

FIG. 15 is a flowchart illustrating an example of data collection process of the master station according to the first embodiment.

FIG. 16 is a flowchart illustrating an example of data collection process of the monitoring and control device according to the first embodiment.

FIG. 17 is a flowchart illustrating an example of data setting process of the monitoring and control device according to the first embodiment.

FIG. 18 is a flowchart illustrating an example of data setting process of the master station according to the first embodiment.

FIG. 19 is a flowchart illustrating an example of data setting process of the slave station according to the first embodiment.

FIG. 20 is a diagram illustrating an example of hardware configuration of the slave station and of the master station according to the first embodiment.

FIG. 21 is a diagram illustrating an example configuration of a monitoring and control system according to a second embodiment.

FIG. 22 is a diagram illustrating an example configuration of the master station according to the second embodiment.

FIG. 23 is a diagram illustrating an example configuration of the slave station according to the second embodiment.

FIG. 24 is a diagram illustrating an example configuration of a monitoring and control system according to a third embodiment.

FIG. 25 is a diagram illustrating an example configuration of the monitoring and control device according to the third embodiment.

FIG. 26 is a diagram illustrating an example structure of a slave station list according to the third embodiment.

FIG. 27 is a diagram illustrating an example configuration of the master station according to the third embodiment.

FIG. 28 is a flowchart illustrating an example of data setting process of the monitoring and control device according to the third embodiment.

FIG. 29 is a flowchart illustrating an example of data setting process of the master station according to the third embodiment.

### DESCRIPTION OF EMBODIMENTS

A monitoring and control system according to embodiments of the present invention will be described in detail below with reference to the drawings. Note that these embodiments are not intended to limit the scope of this invention.

### First Embodiment

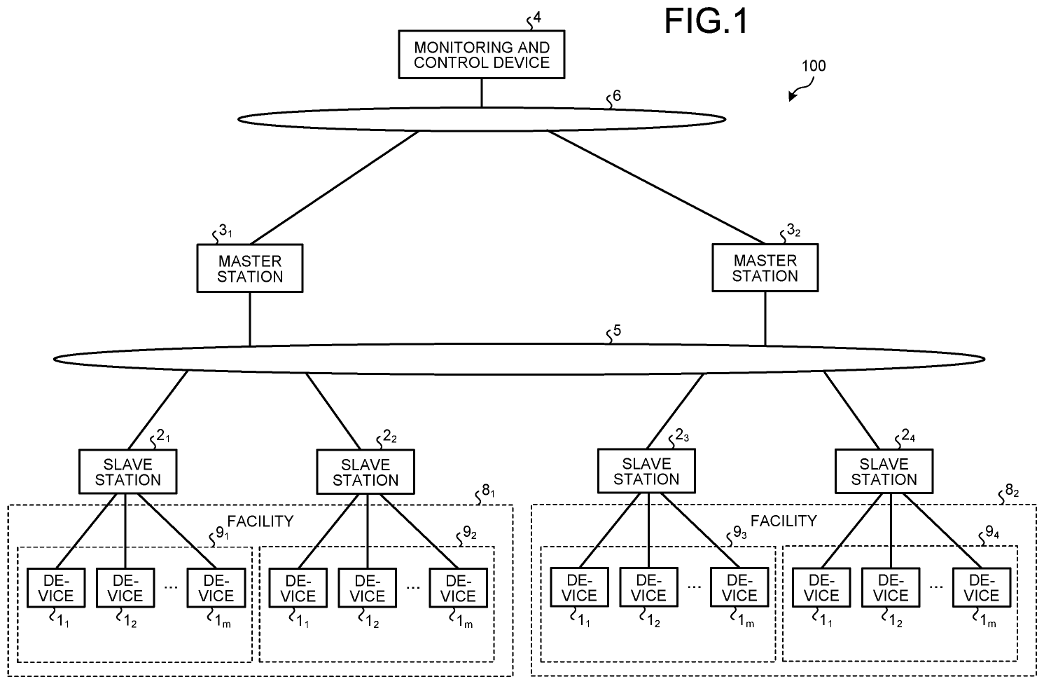

FIG. 1 is a diagram illustrating an example configuration of a monitoring and control system according to a first embodiment of the present invention. A monitoring and control system 100 illustrated in FIG. 1 monitors the states of facilities 8₁ and 8₂ and controls the facilities 8₁ and 8₂. Examples of the facilities 8₁ and 8₂ include plants, such as a water treatment plant, a power plant, and a factory, and public facilities. The facilities 8₁ and 8₂ are each hereinafter referred to as facility 8 when no distinction is made between them. The facilities 8₁ and 8₂ are managed by different business entities, and the monitoring and control system 100 can provide multi-tenant monitoring and control service. Note that the facilities 8₁ and 8₂ may be managed by the same business entity. In addition, in a similar manner to the case of monitoring and control of the facilities 8, the monitoring and control system 100 can also monitor and control a facility including multiple devices.

As illustrated in FIG. 1, the facility 8₁ includes areas 9₁ and 9₂, in each of which devices 1₁ to 1ₘ are disposed, and the facility 8₂ includes areas 9₃ and 9₄, in each of which devices 1₁ to 1ₘ are disposed, where m is an integer greater than or equal to 2. The devices 1₁ to 1ₘ are each hereinafter referred to as device 1 when no distinction is made between them. Note that part or all of the devices 1₁ to 1ₘ are of different types between the areas 9₁, 9₂, 9₃, and 9₄, but the example illustrated in FIG. 1 uses the same set of reference characters for convenience of illustration. In addition, the areas 9₁, 9₂, 9₃, and 9₄ are each hereinafter referred to as area 9 when no distinction is made between them. The example illustrated in FIG. 1 illustrates m devices 1 being disposed in each of the areas 9, but different numbers of devices 1 may be disposed in different areas 9. That is, the number of the devices 1 disposed in each of the areas 9 is not limited to the number as illustrated in the example illustrated in FIG. 1.

The device 1 is a device that constitutes the facility 8, and includes a condition measurement device of a type suitable for monitoring purpose of the device. Examples of the condition measurement device include a rain gauge, a water level indicator, a pressure gauge, a temperature sensor, a voltage sensor, a current sensor, a flow rate sensor, and a position sensor. Targets to be measured by the condition measurement device include the device 1 and the target to be controlled by the device 1. In a case of a power plant, targets to be controlled by the device 1 are, for example, the generated voltage and the generated power. The device 1 outputs first data including at least one of a measurement value obtained by measurement of a measurement target by the condition measurement device and a state value representing the state of the device 1.

The monitoring and control system 100 includes slave stations 2₁ to 2₄ that each collect first data output from each of the multiple devices 1; master stations 3₁ and 3₂; and a monitoring and control device 4 that collects the first data from the slave stations 2₁ to 2₄ via the master stations 3₁ and 3₂ and transmits second data for controlling each of the devices 1 to the slave stations 2₁ to 2₄ via the master stations 3₁ and 3₂. Note that the master station 3₁ transmits and receives data to and from the slave stations 2₁ and 2₂, and the master station 3₂ transmits and receives data to and from the slave stations 2₃ and 2₄.

The slave stations 2₁ to 2₄ are each hereinafter referred to as slave station 2 when no distinction is made between them. In addition, the master stations 3₁ and 3₂ are each hereinafter referred to as master station 3 when no distinction is made between them. The example illustrated in FIG. 1 illustrates two master stations 3, but the number of the master stations 3 may be three or more or may be one. Moreover, each of the master stations 3 has two slave stations 2 assigned thereto, but three or more slave stations 2 may be assigned to one master station 3, or one slave station 2 may be assigned to one master station 3.

The slave station 2 is communicably connected to the master station 3 via a communication network 5. In addition, the master station 3 is communicably connected to the monitoring and control device 4 via a communication network 6. The communication network 5 is, for example, a local area network (LAN) or a wide area network (WAN). The communication network 6 is, for example, a WAN such as the Internet.

The example illustrated in FIG. 1 illustrates the communication networks 5 and 6 as separate communication networks, but the communication networks 5 and 6 may be the same communication network. For example, the communication networks 5 and 6 may both be the Internet. Otherwise, the communication network connecting together the master station 3₁ and the slave stations 2₁ and 2₂ may be a different network from the communication network connecting together the master station 3₂ and the slave stations 2₃ and 2₄.

The monitoring and control device 4 is a virtual device formed by one or more servers and one or more storages that together constitute a cloud system established in a data center. The multiple devices such as the server(s) and the storage(s) that constitute the cloud are communicably connected to one another by the communication network 6 or by a communication network not illustrated.

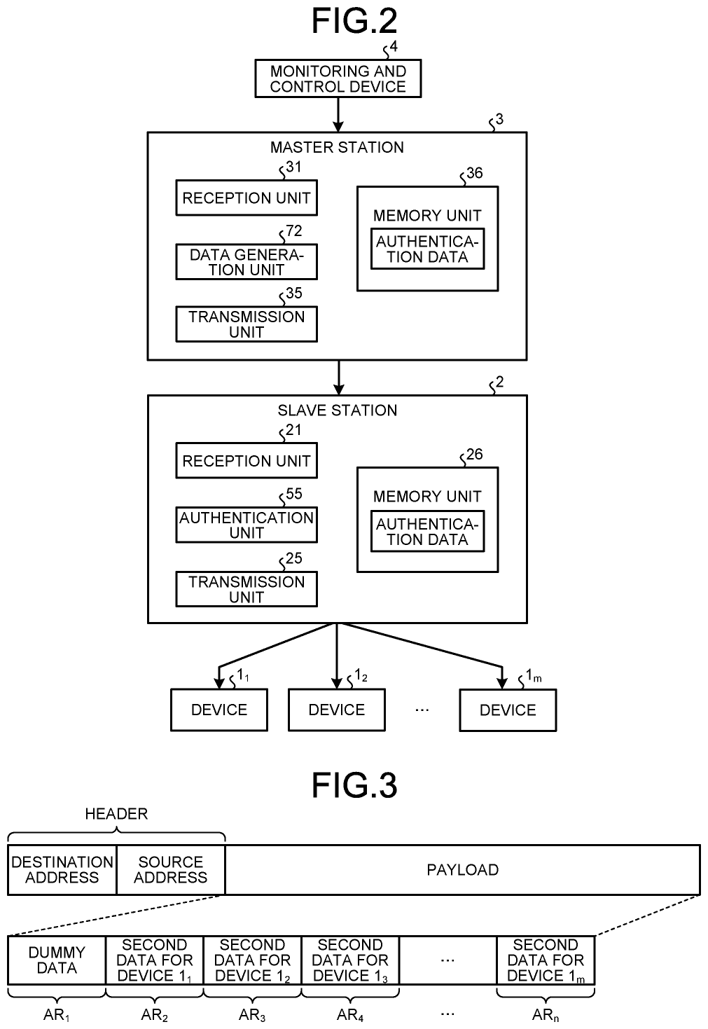

A description will be given of a flow of process in the monitoring and control system 100 of transmission of first control data including the second data for the devices 1₁ to 1ₘ from the monitoring and control device 4 via the master station 3 to the slave station 2 and of setting of the second data in the devices 1. FIG. 2 is a diagram for describing processing of setting of the second data in the devices by the monitoring and control system according to the first embodiment. FIG. 3 is a diagram illustrating an example of format of a data packet transmitted from the master station to the slave station according to the first embodiment.

The master station 3 includes a reception unit 31, a data generation unit 72, a transmission unit 35, and a memory unit 36. The memory unit 36 stores authentication data. The memory unit 36 is an example of a first memory unit. The reception unit 31 is an example of a first reception unit. The transmission unit 35 is an example of a first transmission unit.

The reception unit 31 receives, from the monitoring and control device 4, the first control data, which is a data packet containing, in a payload thereof, a data set including the second data for the devices 1₁ to 1ₘ, and outputs the data set contained in the payload of the first control data received. The data generation unit 72 reads the authentication data from the memory unit 36, and generates dummy data including the authentication data that has been read. The data generation unit 72 also generates payload data including the dummy data generated and the data set output from the reception unit 31.

The transmission unit 35 transmits, to the slave station 2, second control data, which is a data packet containing, in a payload thereof, the payload data generated by the data generation unit 72. The second control data transmitted from the master station 3 to the slave station 2 has a format including a header and a payload as illustrated in FIG. 3. The header has a destination address area for storing the network address of the slave station 2 that is the destination, and a source address area for storing the network address of the master station 3 that is the source. Note that the term “network address” is hereinafter referred to simply as “address”.

The payload has an area including multiple data areas AR₁ to ARₙ each defined to store the second data. The data area AR₁ stores the dummy data including the authentication data, and the multiple data areas AR₁ to ARₙ other than the data area AR₁, i.e., the data areas AR₂ to ARₙ, each store the second data. Data including the authentication data is herein referred to as “dummy data” because, despite not being data for the devices 1, the data is stored in one area of the multiple data areas AR₁ to ARₙ each defined in the payload to store data for the devices 1. Such data can thus be referred to also as “non-device data”.

In the example illustrated in FIG. 3, the data areas AR₂ to ARₙ respectively store the second data for the devices 1₁ to 1ₘ. For example, the data area AR₂ stores the second data for the device 1₁; the data area AR₃ stores the second data for the device 1₂; the data area AR₄ stores the second data for the device 1₃; and the data area ARₙ stores the second data for the device 1ₘ. Note that the example illustrated in FIG. 3 assumes a relationship of n=m+1, but n and m may satisfy a relationship of n>m+1. The data areas AR₁ to ARₙ are each hereinafter referred to as data area AR when no distinction is made.

The transmission unit 35 transmits, to the slave station 2, the second control data including, in the payload thereof, the payload data having the dummy data including the authentication data stored in the data area AR₁ and having the second data stored in the data areas AR₂ to ARₙ. Thus, the master station 3 transmits, to the slave station 2, the second control data including, in the payload thereof, the payload data having the dummy data stored in an excess area not for storing the second data, of the multiple data areas AR₁ to ARₙ defined to store the second data.

The slave station 2 includes a reception unit 21, an authentication unit 55, a transmission unit 25, and a memory unit 26. The memory unit 26 stores authentication data. The memory unit 26 is an example of a second memory unit. The reception unit 21 is an example of a second reception unit. The transmission unit 25 is an example of a second transmission unit.

The reception unit 21 receives the second control data from the master station 3. The authentication unit 55 determines whether the authentication data included in the data area AR₁, which is one data area, in the payload of the second control data received by the reception unit 21 matches the authentication data stored in the memory unit 26.

The transmission unit 25 transmits each piece of the second data included in the data set in the second control data to the corresponding device 1 of the multiple devices 1₁ to 1ₘ in a case in which the authentication unit 55 determines that the authentication data included in the data area AR₁, which is one data area, matches the authentication data stored in the memory unit 26. For example, the transmission unit 25 transmits the second data for the device 1₁ stored in the data area AR₂, to the device 1₁, transmits the second data for the device 1₂ stored in the data area AR₃, to the device 1₂, and transmits the second data for the device 1ₘ stored in the data area AR_{E}, to the device 1ₘ.

As described above, the slave station 2 transmits each piece of the second data included in the data set in the second control data to the corresponding device 1 of the multiple devices 1₁ to 1ₘ if the authentication data included in the data area AR₁, which is one data area, matches the authentication data stored in the memory unit 26. This enables only the data packet rightfully transmitted from the master station 3 to be accepted, and can thus prevent unauthorized control.

Besides, the authentication data to be used in authentication is stored in the area in the payload defined to store the second data. This enables the monitoring and control system 100 to provide authentication without requiring the authentication data to be carried in the header of the data packet, and thus to reduce or eliminate the effect on the system configuration. Moreover, the authentication data to be used in authentication is stored, as dummy data, in an excess area not for storing the second data, of the multiple data areas AR₁ to ARₙ defined in the payload to store the second data. This enables the monitoring and control system 100 to further reduce or eliminate the effect on the system configuration.

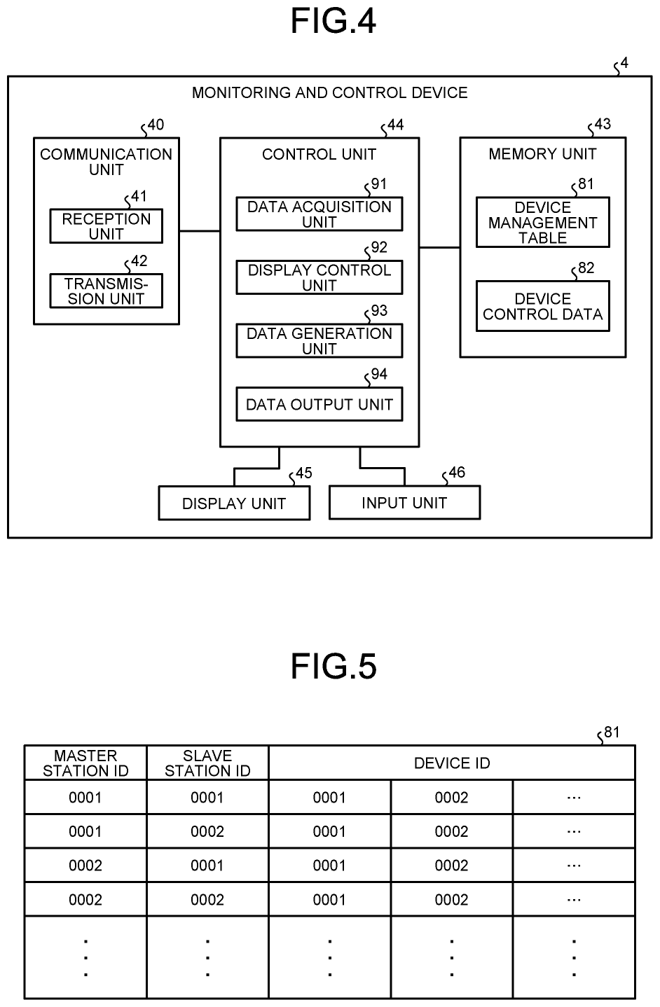

A configuration of the monitoring and control system 100 according to the first embodiment will be described in more detail below in order of the monitoring and control device 4, the master station 3, and the slave station 2. FIG. 4 is a diagram illustrating an example configuration of the monitoring and control device according to the first embodiment, focusing on elements for providing a part of the functionality of the monitoring and control device 4.

As illustrated in FIG. 4, the monitoring and control device 4 includes a communication unit 40, a memory unit 43, a control unit 44, a display unit 45, and an input unit 46. The communication unit 40 is a communication interface that transmits and receives data to and from the master station 3 via the communication network 6, and includes a reception unit 41 and a transmission unit 42.

The reception unit 41 receives, from the master station 3, second collection data, which is a data packet containing, in a payload thereof, a data set including the first data from the devices 1₁ to 1ₘ, via the communication network 6. The transmission unit 42 transmits, to the master station 3, the first control data including, in the payload thereof, the second data for the devices 1₁ to 1ₘ, via the communication network 6.

The memory unit 43 stores the first data collected from the slave stations 2₁ to 2₄ via the master stations 3₁ and 3₂. Note that the first data collected via the slave stations 2₁ and 2₂ is collected by the monitoring and control device 4 via the master station 3₁, and the first data collected via the slave stations 2₃ and 2₄ is collected by the monitoring and control device 4 via the master station 3₂.

The memory unit 43 also stores a device management table 81, which represents relationships among the master stations 3, the slave stations 2, and the devices 1; and device control data 82 including the second data to be set in the devices 1. The device control data 82 is stored in the memory unit 43 by the control unit 44 based on, for example, operator's input to the input unit 46.

FIG. 5 is a diagram illustrating an example of device management table according to the first embodiment. The device management table 81 illustrated in FIG. 5 includes information including “master station ID”, “slave station ID”, and “device ID” associated with one another. “Master station ID” is identification data of a master station 3. “Slave station ID” is identification data of a slave station 2. “Device ID” is identification data of a device 1.

In the example illustrated in FIG. 5, the master station ID is identification data unique to each master station 3. In addition, the slave station ID is identification data unique to each one of the multiple slave stations 2 that are related to the same master station 3. The expression “related to a master station 3” means that a slave station 2 is configured to be communicable with that master station 3. For example, the slave stations 2₁ and 2₂ are both related to the same master station 3, which is the master station 3₁, and are thus assigned identification data values “0001” and “0002” that are different from each other.

Similarly, the slave stations 2₃ and 2₄ are both related to the same master station 3, which is the master station 3₂, and are thus assigned identification data values “0001” and “0002” that are different from each other. The slave stations 2₁ and 2₂ and the slave stations 2₃ and 2₄ are related to different master stations 3, and are thus assigned the same set of identification data values. However, the identification data of the slave stations 2 may be identification data unique to each slave station 2.

The device ID is identification data unique to each one of the multiple devices 1 that are related to the same slave station 2. The expression “related to a slave station 2” means that a device 1 is configured to be communicable with that slave station 2. For example, the devices 1₁ to 1ₘ in the area 9₁ are all related to the same slave station 2, which is the slave station 2₁, and are thus assigned identification data values “0001”, “0002”, and the like that are different from each other.

Similarly, the devices 1₁ to 1ₘ in the area 9₂ are all related to the same slave station 2, which is the slave station 2₂, and are thus assigned identification data values “0001”, “0002”, and the like that are different from each other. The devices 1₁ to 1ₘ in the area 9₁ and the devices 1₁ to 1ₘ in the area 9₂ are related to different slave stations 2, and are thus assigned the same set of identification data values. However, the identification data of the devices 1 may be identification data unique to each device 1.

Referring back to FIG. 4, the description of the monitoring and control device 4 will be continued. The control unit 44 transmits and receives data to and from the master stations 3₁ and 3₂ via the communication unit 40 and via the communication network 6. The control unit 44 includes a data acquisition unit 91, a display control unit 92, a data generation unit 93, and a data output unit 94.

The data acquisition unit 91 obtains, via the reception unit 41, the first data output from the devices 1₁ to 1ₘ in the areas 9₁ and 9₂ from the master station 3₁ via the slave stations 2₁ and 2₂, and obtains, via the reception unit 41, the first data output from the devices 1₁ to 1ₘ in the areas 9₃ and 9₄ from the master station 3₂ via the slave stations 2₃ and 2₄. The data acquisition unit 91 stores the first data obtained, in the memory unit 43.

The display control unit 92 is capable of displaying the first data obtained by the data acquisition unit 91 and stored in the memory unit 43, on the display unit 45. The display control unit 92 is capable of displaying, on the display unit 45, a control screen (not illustrated) for controlling the devices 1₁ to 1ₘ in each of the areas 9₁ to 9₄. The control unit 44 is capable of generating and updating the second data, which is data to be set in the devices 1 for controlling the devices 1, based on an input to the input unit 46 by an administrator of the monitoring and control device 4 or the like. The control unit 44 is capable of adding a generated piece of the second data to the device control data 82 and of updating the device control data 82.

The data generation unit 93 generates a data set including the second data included in the device control data 82 upon storing anew of the device control data 82 in the memory unit 43 or upon updating of the device control data 82. The data generation unit 93 also generates monitored-and-controlled-device data including data that associates each piece of the second data in the data set with the corresponding device ID, and the slave station IDs. For example, in a case in which the second data is arranged in order of the devices 1₁ to 1ₘ in the data set, the monitored-and-controlled-device data includes the device IDs in order of the devices 1₁ to 1ₘ. Note that the monitored-and-controlled-device data may be data including data indicating the locations of respective pieces of the second data in the data set and the device IDs.

Assume, for example, that the second data for the devices 1₁ to 1ₘ in the area 9₁ have been updated in the device control data 82. In this case, the data generation unit 93 generates a data set including the second data for the devices 1₁ to 1ₘ in the area 9₁, and generates monitored-and-controlled-device data including the device IDs of the devices 1₁ to 1ₘ in the area 9₁ and including the slave station ID of the slave station 2₁.

In addition, assume that the second data for the devices 1₁ to 1ₘ in the area 9₂ have been updated in the device control data 82. In this case, the data generation unit 93 generates a data set including the second data for the devices 1₁ to 1ₘ in the area 9₂, and generates monitored-and-controlled-device data including the device IDs of the devices 1₁ to 1ₘ in the area 9₂ and including the slave station ID of the slave station 2₂.

The data output unit 94 outputs, to the communication unit 40, the monitored-and-controlled-device data and the data set generated by the data generation unit 93 each time the monitored-and-controlled-device data and the data set are generated by the data generation unit 93. The transmission unit 42 of the communication unit 40 transmits the first control data, which is a data packet containing the monitored-and-controlled-device data and the data set output from the data output unit 94, to the master station 3 via the communication network 6. The first control data includes the address of the monitoring and control device 4 as the source address and the address of the master station 3 as the destination address.

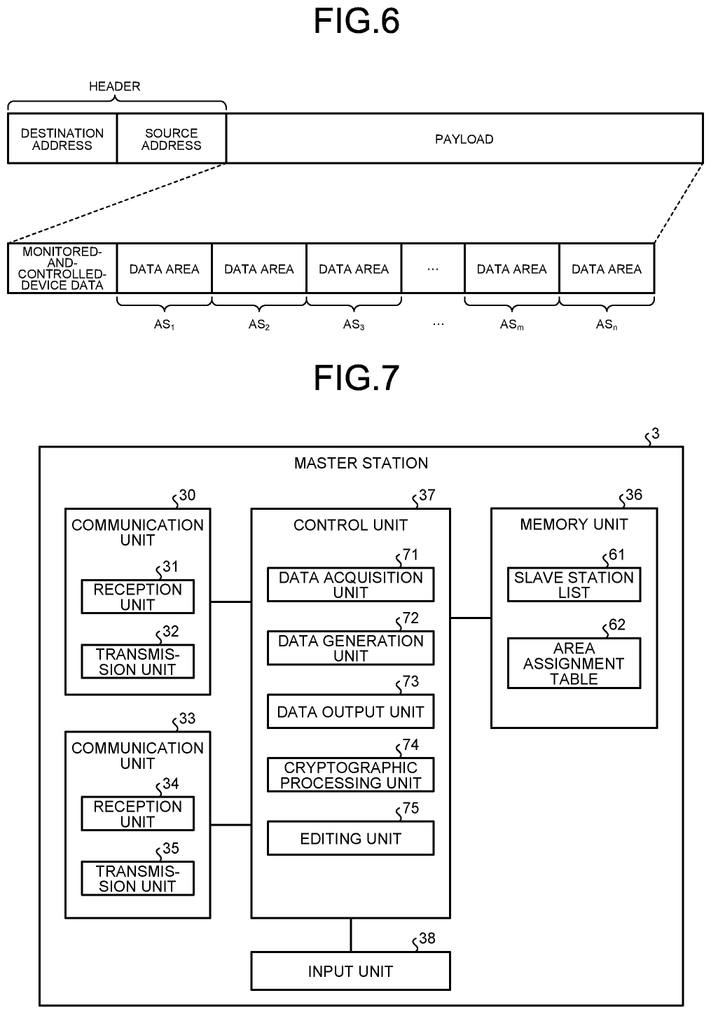

The first control data transmitted from the transmission unit 42 is a data packet having a first format. FIG. 6 is a diagram illustrating an example of the first format, which is the format of data packets transmitted and received between the monitoring and control device and the master station according to the first embodiment. The first format includes, as illustrated in FIG. 6, a header and a payload.

The header has a destination address area for storing the destination address, and a source address area for storing the source address. The payload includes the monitored-and-controlled-device data and multiple data areas AS₁ to ASₙ. In the example illustrated in FIG. 6, the data areas AS₁ to ASₘ contain the second data for the devices 1₁ to 1ₘ. The data areas AS₁ to ASₙ are each hereinafter referred to as data area AS when no distinction is made between them.

A configuration of the master station 3 will next be described. FIG. 7 is a diagram illustrating an example configuration of the master station according to the first embodiment. As illustrated in FIG. 7, the master station 3 includes communication units 30 and 33, the memory unit 36, a control unit 37, and an input unit 38.

The communication unit 30 is a communication interface that transmits and receives data to and from the monitoring and control device 4 via the communication network 6, and includes the reception unit 31 and a transmission unit 32. The reception unit 31 receives, from the monitoring and control device 4, the first control data including, in the payload thereof, the data set including the second data for the devices 1₁ to 1ₘ, via the communication network 6. The transmission unit 32 transmits, to the monitoring and control device 4, the second collection data including, in the payload thereof, the data set including the first data from the devices 1₁ to 1ₘ, via the communication network 6. The first control data and the second collection data transmitted and received between the master station 3 and the monitoring and control device 4 are each a data packet having the first format illustrated in FIG. 6 described above.

The communication unit 33 is a communication interface that transmits and receives data to and from the slave stations 2₁ and 2₂ via the communication network 5, and includes a reception unit 34 and the transmission unit 35. The reception unit 34 is an example of a third reception unit. The reception unit 34 receives, from the slave station 2, the first collection data including, in the payload thereof, the data set including the first data from the devices 1₁ to 1ₘ, via the communication network 5. The transmission unit 35 transmits, to the slave station 2, the second control data including, in the payload thereof, the data set including the second data for the devices 1₁ to 1ₘ, via the communication network 5.

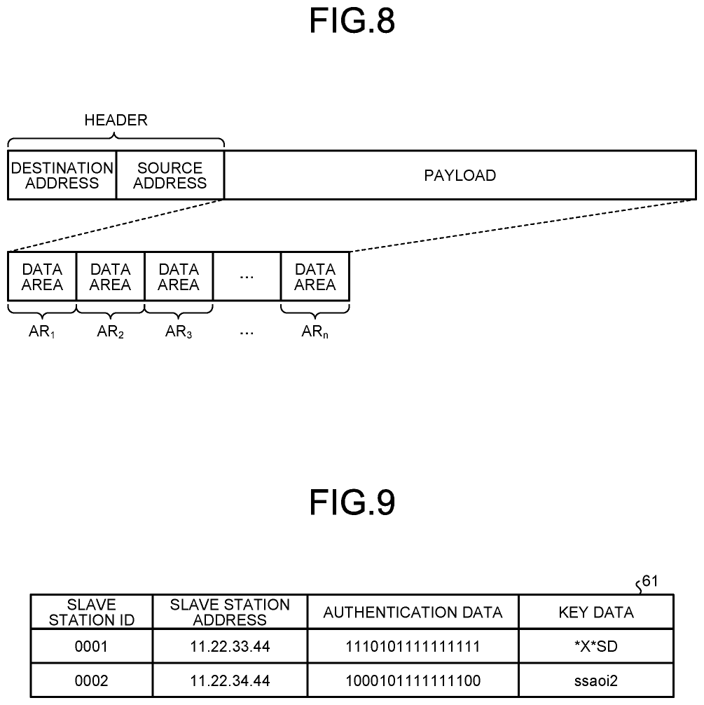

The second control data and the first collection data transmitted and received between the slave station 2 and the master station 3 are each a data packet having a second format. FIG. 8 is a diagram illustrating an example of the second format, which is the format of data packets transmitted and received between the slave station and the master station according to the first embodiment. As illustrated in FIG. 8, the second format includes a header and a payload. The header has a destination address area for storing the destination address and a source address area for storing the source address. The payload includes the multiple data areas AR₁ to ARₙ defined to store the first data or the second data.

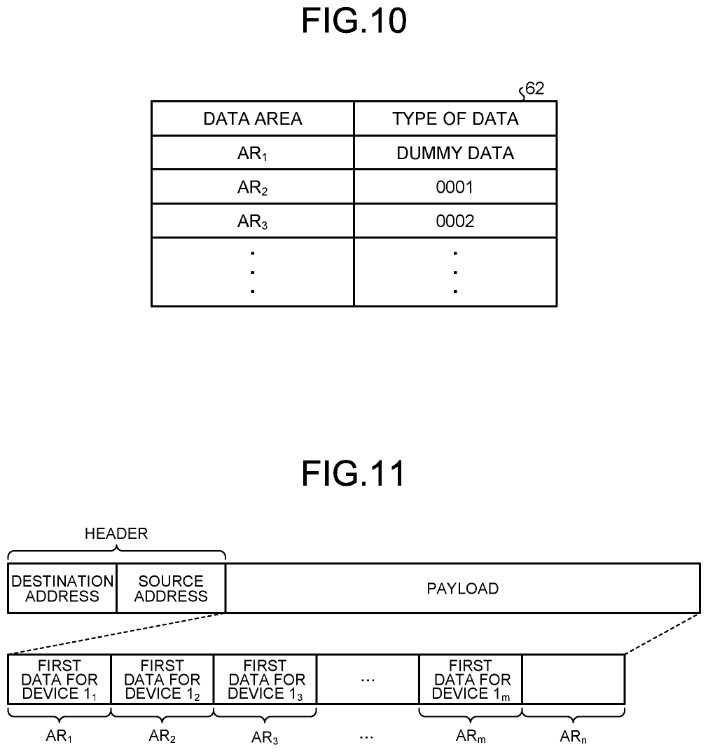

The memory unit 36 stores a slave station list 61 and an area assignment table 62. FIG. 9 is a diagram illustrating an example of the slave station list according to the first embodiment, and FIG. 10 is a diagram illustrating an example of the area assignment table according to the first embodiment.

The slave station list 61 includes information for use in communication with the slave station 2. In the example illustrated in FIG. 9, the slave station list 61 includes information that associates “slave station ID”, “slave station address”, “authentication data”, and “key data” with one another. “Slave station ID” is identification data of a slave station 2. “Slave station address” is the address of a slave station 2 in the communication network 5.

“Authentication data” is authentication data unique to each slave station 2. The authentication data illustrated in FIG. 9 is represented in a binary data format, but the authentication data may also be represented in an ASCII data format or the like. “Key data” is key data unique to each slave station 2. “Key data” is key data common to encryption and decryption. Note that the key data illustrated in FIG. 9 is ASCII data, but the key data may also be binary data. The example illustrated in FIG. 9 provides key data in a common-key system, but the key data may also be key data in a public-key system. In such case, the key data will include public key data and secret key data. In addition, in the example illustrated in FIG. 9, the key data is key data unique to each slave station 2, but may also be key data unique to each master station 3. That is, the key data may be key data common to slave stations.

The area assignment table 62 includes information that indicates the type of data stored in the multiple data areas AR₁ to ARₙ described above contained in the payload of the data packet communicated between the master station 3 and the slave station 2. The area assignment table 62 illustrated in FIG. 10 includes information that associates “data area” and “type of data” with each other.

“Data area” is information for specifying the data area AR, and “type of data” is information for specifying the device 1, or dummy data. The information for specifying the device 1 is the device ID, but may be any information that specifies the device 1. In the example illustrated in FIG. 10, the data area AR₁ is associated with dummy data, the data area AR₂ is associated with the device ID “0001”, and the data area AR₃ is associated with the device ID “0002”.

Note that the foregoing description has described the slave station list 61 formed of a single list that associates “slave station ID” with “slave station address”, “authentication data”, and “key data”. However, the slave station list 61 may be formed of multiple lists. For example, the slave station list 61 may have a structure including a list that associates “slave station ID” and “slave station address” with each other, a list that associates “slave station ID” and “authentication data” with each other, and a list that associates “slave station ID” and “key data” with each other.

Referring back to FIG. 7, the description of the master station 3 will be continued. The control unit 37 transmits and receives data packets to and from the monitoring and control device 4 via the communication unit 30 and via the communication network 6, and transmits and receives data packets to and from the slave stations 2 via the communication unit 33 and via the communication network 5. The control unit 37 includes a data acquisition unit 71, the data generation unit 72, a data output unit 73, a cryptographic processing unit 74, and an editing unit 75. The cryptographic processing unit 74 is an example of a first cryptographic processing unit.

The data acquisition unit 71 obtains, from the reception unit 31, the payload data, which is the data contained in the payload of the first control data. The first control data is a data packet having the first format illustrated in FIG. 6. The payload of the first control data includes the monitored-and-controlled-device data and the data set including the second data for the devices 1₁ to 1ₘ.

The data generation unit 72 extracts the slave station ID included in the monitored-and-controlled-device data obtained by the data acquisition unit 71, and obtains the authentication data associated with the slave station ID extracted, from the slave station list 61. The data generation unit 72 then generates dummy data including the slave station ID extracted and the authentication data obtained.

The data generation unit 72 also extracts the second data for each of the devices 1 based on the device IDs included in the monitored-and-controlled-device data obtained by the data acquisition unit 71. The data generation unit 72 generates, based on the area assignment table 62, the payload data including the dummy data generated and the data set storing, in order, the second data for the devices 1₁ to 1ₘ.

For example, in a case in which the area assignment table 62 is as illustrated in FIG. 10, the data area AR₁ stores the dummy data, the data area AR₂ stores the second data for the device 1₁, and the data area AR₃ stores the second data for the device 1₂. The second data for each of the devices 1₃ to 1ₘ is also stored in the corresponding data area AR defined in the area assignment table 62.

The cryptographic processing unit 74 encrypts the payload data generated by the data generation unit 72, based on the slave station list 61. For example, assume that the second control data is data to be transmitted to the slave station 2 having the slave station ID “0002”. In this case, the cryptographic processing unit 74 obtains the key data “ssaoi2” associated with the slave station ID “0002” from the slave station list 61, and encrypts the payload data using the key data “ssaoi2” obtained.

The data output unit 73 outputs the payload data encrypted by the cryptographic processing unit 74 to the transmission unit 35. In addition, the data output unit 73 extracts, from the slave station list 61, the slave station address associated with the slave station ID included in the monitored-and-controlled-device data, and outputs the slave station address extracted, to the transmission unit 35.

The transmission unit 35 transmits, to the slave station 2, the second control data, which is the data packet containing the payload data output from the data output unit 73 in the payload, via the communication network 5. The second control data includes the slave station address output from the data output unit 73 as the destination address. Thus, the second control data is transmitted to the slave station 2 having the slave station ID included in the monitored-and-controlled-device data. Note that the second control data includes the address of the master station 3 transmitting the second control data, as the source address.

As described above, upon obtaining the first control data including the second data for the devices 1₁ to 1ₘ, the master station 3 transmits, to the slave station 2, the second control data including, in the payload thereof, the dummy data including the authentication data and the slave station ID of the slave station 2, in addition to the second data for the devices 1₁ to 1ₘ.

The data acquisition unit 71 also obtains the payload data and the source address of the first collection data from the reception unit 34. The payload data of the first collection data has been encrypted by the slave station 2, and thus the cryptographic processing unit 74 decrypts the payload data obtained by the data acquisition unit 71, based on the slave station list 61.

For example, assume that the area assignment table 62 is as illustrated in FIG. 10 and that the first collection data is data transmitted from the slave station 2 having a slave station address “11.22.33.44”. In this case, the cryptographic processing unit 74 obtains the key data “*X*SD” associated with the slave station address “11.22.33.44” from the slave station list 61, and then decrypts the payload data obtained by the data acquisition unit 71 using the key data “*X*SD” obtained.

The first collection data is a data packet having the second format illustrated in FIG. 8, and when the operation mode is set to dummy setting mode, the dummy data is stored in one data area AR of the data areas AR₁ to ARₙ. When the operation mode is set to dummy setting mode, the data acquisition unit 71 extracts the dummy data and the first data from the devices 1₁ to 1ₘ from the payload data in the first collection data decrypted by the cryptographic processing unit 74, based on the area assignment table 62.

The dummy data includes the slave station ID and the authentication data of the slave station 2 that has output the first collection data. The data acquisition unit 71 obtains, from the slave station list 61, the slave station address associated with the slave station ID included in the dummy data obtained from the reception unit 34. The data acquisition unit 71 then determines whether the source address obtained from the reception unit 34 matches the slave station address obtained from the slave station list 61.

For example, assume that the slave station list 61 stored in the memory unit 36 is as illustrated in FIG. 9 and that the slave station ID included in the dummy data is “0001”. In this case, the data acquisition unit 71 determines that there is a match if the source address obtained from the reception unit 34 is “11.22.33.44”. Alternatively, if the source address obtained from the reception unit 34 is not “11.22.33.44”, the data acquisition unit 71 determines that there is no match. This can prevent unauthorized setting of authentication data in the memory unit 36.

Upon determination that the source address matches the slave station address obtained from the slave station list 61, the data acquisition unit 71 determines whether the authentication data associated with the slave station ID included in the dummy data exists in the slave station list 61. Upon determination of non-existing of the authentication data that is associated with the slave station ID identical to the slave station ID included in the dummy data, of the multiple slave station IDs in the slave station list 61, the data acquisition unit 71 adds the authentication data included in the dummy data to the slave station list 61 to associate the authentication data with the slave station ID identical to the slave station ID included in the dummy data.

This enables the authentication data to be associated with the slave station ID of a slave station 2 that has no authentication data in the slave station list 61. Thus, even when no authentication data is associated with each one of the slave station IDs in the slave station list 61, the slave station list 61 having authentication data associated with each of the slave station IDs can be automatically generated.

The data acquisition unit 71 can also associate the authentication data included in the dummy data with the slave station ID identical to the slave station ID included in the dummy data, of the multiple slave station IDs in the slave station list 61 irrespective of whether the authentication data has been set in the slave station list 61. In a case in which the authentication data has been associated with the slave station ID identical to the slave station ID included in the dummy data in the slave station list 61, the data acquisition unit 71 can overwrite and update the authentication data in the slave station list 61 with the authentication data included in the dummy data. This enables the slave station list 61 to be updated with respect to the slave station 2 each time the authentication data is changed, and can thus enhance prevention of unauthorized control of the slave station 2.

FIG. 11 is a diagram illustrating an example structure of the first collection data transmitted from the slave station to the master station when the operation mode of each of the slave station and the master station is set to non-dummy setting mode, according to the first embodiment. When the operation mode of the slave station 2 is set to non-dummy setting mode, the data areas AR₁ to ARₘ in the payload of the first collection data store the first data from the devices 1₁ to 1ₘ only, as illustrated in FIG. 11

In addition, when the operation mode is set to non-dummy setting mode, the data acquisition unit 71 extracts the first data from the devices 1₁ to 1ₘ arranged in a predetermined order as illustrated in FIG. 11, from the payload data of the first collection data. Note that the slave station 2 and the master station 3 related to each other are commonly set to either dummy setting mode or non-dummy setting mode as the operation mode.

The editing unit 75 edits the slave station list 61 based on an input to the input unit 38. This allows the slave station address, the authentication data, and the key data in the slave station list 61 to be configured and updated. Note that the editing unit 75 does not configure or update the authentication data when the operation mode is set to non-dummy setting mode.

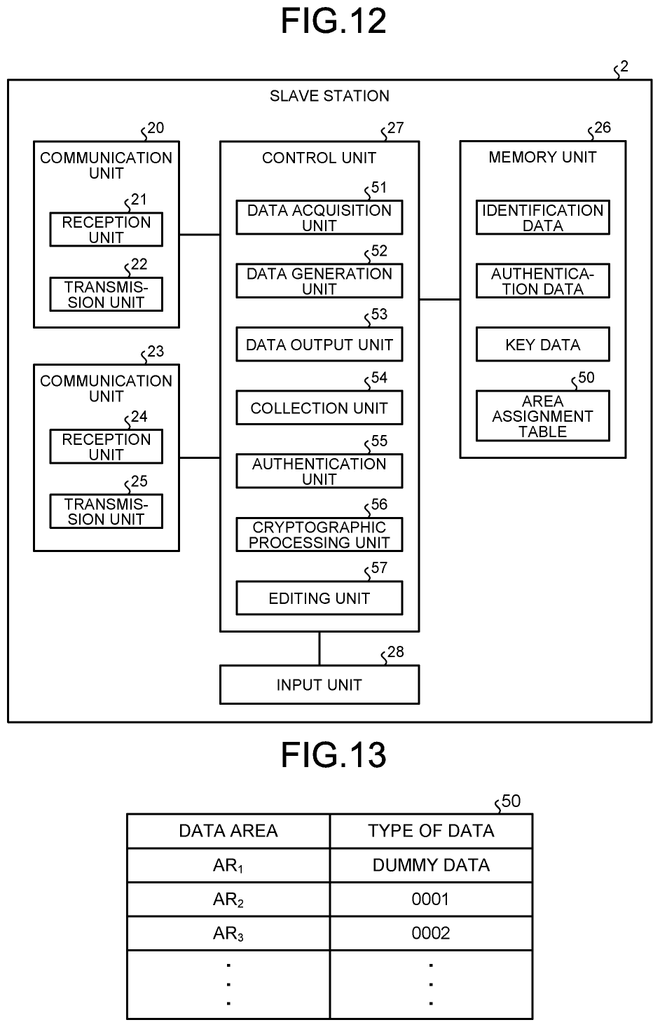

A configuration of the slave station 2 will next be described. FIG. 12 is a diagram illustrating an example configuration of the slave station according to the first embodiment. As illustrated in FIG. 12, the slave station 2 includes communication units 20 and 23, the memory unit 26, a control unit 27, and an input unit 28.

The communication unit 20 is a communication interface that transmits and receives data to and from the master station 3 via the communication network 5, and includes the reception unit 21 and a transmission unit 22. The reception unit 21 receives the second control data from the master station 3 via the communication network 5. The transmission unit 22 is an example of a third transmission unit. The transmission unit 22 transmits the first collection data storing, in the payload thereof, the data set including the first data from the devices 1₁ to 1ₘ, to the master station 3 via the communication network 6. The second control data and the first collection data transmitted and received between the slave station 2 and the master station 3 are each a data packet having the second format illustrated in FIG. 8 described above.

The communication unit 23 is a communication interface that transmits and receives data to and from the individual devices 1, and includes a reception unit 24 and the transmission unit 25. The reception unit 24 receives the first data from the individual devices 1 via a communication channel (not illustrated). The transmission unit 25 transmits the second data to the individual devices 1 via a communication channel (not illustrated). The communication channel between the slave station 2 and the device 1 is a communication line or a communication network. A communication line may be provided for each of the devices 1. The communication network may also be a network shared by the devices 1₁ to 1ₘ.

The memory unit 26 stores identification data, authentication data, key data, and an area assignment table 50. The identification data is the slave station ID. The authentication data is authentication data unique to each slave station 2. The key data is key data unique to each slave station 2. For example, in a case in which the master station 3 stores the slave station list 61 illustrated in FIG. 9, the slave station 2 having the slave station ID “0001” has authentication data of “1110101111111111” and key data of “*X*SD”. In addition, the slave station 2 having the slave station ID “0002” has authentication data of “1000101111111100” and key data of “ssaoi2”.

The area assignment table 50 includes information that indicates the type of data stored in the multiple data areas AR₁ to ARₙ described above contained in the payload of the data packet communicated between the slave station 2 and the master station 3. FIG. 13 is a diagram illustrating an example of the area assignment table according to the first embodiment. As illustrated in FIG. 13, the area assignment table 50 includes the same information as that of the area assignment table 62.

As illustrated in FIG. 12, the control unit 27 includes a data acquisition unit 51, a data generation unit 52, a data output unit 53, a collection unit 54, the authentication unit 55, a cryptographic processing unit 56, and an editing unit 57. The cryptographic processing unit 56 is an example of a second cryptographic processing unit.

The data acquisition unit 51 obtains, from the reception unit 21, the payload data, which is the data contained in the payload of the second control data. The payload data of the second control data has been encrypted by the master station 3, and the cryptographic processing unit 56 thus decrypts the payload data obtained by the data acquisition unit 51, based on the key data stored in the memory unit 26.

The payload of the second control data contains the dummy data and the second data for the devices 1₁ to 1ₘ. The data acquisition unit 51 extracts, based on the area assignment table 50, the dummy data and the second data for the devices 1₁ to 1ₘ from the payload data of the second control data decrypted by the cryptographic processing unit 56.

The dummy data includes the identification data and the authentication data of the slave station 2. The authentication unit 55 determines whether the authentication data included in the dummy data matches the authentication data stored in the memory unit 26. Specifically, the authentication unit 55 obtains, from the memory unit 26, the authentication data associated with the slave station ID included in the dummy data obtained by the data acquisition unit 51. The control unit 27 then determines whether the authentication data included in the dummy data matches the authentication data obtained from memory unit 26.

For example, assume that the identification data and the authentication data stored in the memory unit 26 are “0001” and “1110101111111111”. In this case, the authentication unit 55 determines that there is a match if the authentication data included in the dummy data is “1110101111111111”, and determines that there is no match if the authentication data included in the dummy data is not “1110101111111111”.

In a case in which the authentication unit 55 determines that the authentication data included in the dummy data matches the authentication data stored in memory unit 26, the data output unit 53 outputs, to the transmission unit 25, the second data for the devices 1₁ to 1ₘ extracted from the payload data of the second control data.

The transmission unit 25 transmits the corresponding pieces of the second data for the devices 1₁ to 1ₘ to the corresponding ones of the devices 1. This causes the second data to be set in the devices 1₁ to 1ₘ, and thus provides remote control of the devices 1₁ to 1ₘ constituting the facility 8.

The collection unit 54 periodically obtains the first data from the devices 1₁ to 1ₘ. Collection of the first data is performed by collecting the first data output from the devices 1₁ to 1ₘ in response to a request from the collection unit 54, but the devices 1₁ to 1ₘ may be configured to automatically and periodically output the first data.

When the operation mode is set to dummy setting mode, the data generation unit 52 obtains the identification data and the authentication data stored in the memory unit 26 from the memory unit 26, and generates dummy data including the identification data and the authentication data obtained.

The data generation unit 52 generates payload data including the dummy data generated and the first data from the devices 1₁ to 1ₘ collected by the collection unit 54 arranged based on the area assignment table 50. For example, the data generation unit 52 generates payload data arranged in the same manner as in the payload illustrated in FIG. 3 in a case in which the area assignment table 50 is as illustrated in FIG. 13.

In addition, when the operation mode is set to non-dummy setting mode, the data generation unit 52 does not generate dummy data, but generates payload data including the first data from the devices 1₁ to 1ₘ collected by the collection unit 54 arranged as illustrated in FIG. 11.

The cryptographic processing unit 56 encrypts the payload data generated by the data generation unit 52, using the key data stored in the memory unit 26. The data output unit 53 outputs the payload data encrypted by the cryptographic processing unit 56 to the transmission unit 22.

The transmission unit 22 transmits, to the master station 3, the first collection data including the payload data output from the data output unit 53 in the payload, via the communication network 5. The first collection data includes the address of the master station 3 output from the data output unit 53 as the destination address, and includes the address of the slave station 2 transmitting the first collection data as the source address.

The editing unit 57 edits the authentication data based on an input to the input unit 28 when the operation mode is set to dummy setting mode. This allows the authentication data to be configured and updated. Note that the editing unit 57 does not configure or update the authentication data when the operation mode is set to non-dummy setting mode.

The editing unit 57 is also capable of editing the area assignment table 50 based on an input to the input unit 28. This allows the type of data to be arbitrarily set for each of the data areas AR. Note that in a case in which the editing unit 57 has edited the area assignment table 50, the data generation unit 52 can include, in the dummy data, the data indicating the data area AR assigned for the dummy data in the area assignment table 50. In this case, the editing unit 75 of the master station 3 can extract the data indicating the data area AR assigned for the dummy data, from the dummy data included in the payload data of the first collection data, and then update the area assignment table 62 based on the data extracted. Note that, in a case in which the data area AR assigned for the dummy data is, for example, the data area AR₂, the editing unit 75 assigns the device 1₁ to device 1ₘ sequentially to the data areas AR₁, AR₃, AR₄, . . . , and the data area ARₙ in the area assignment table 62.

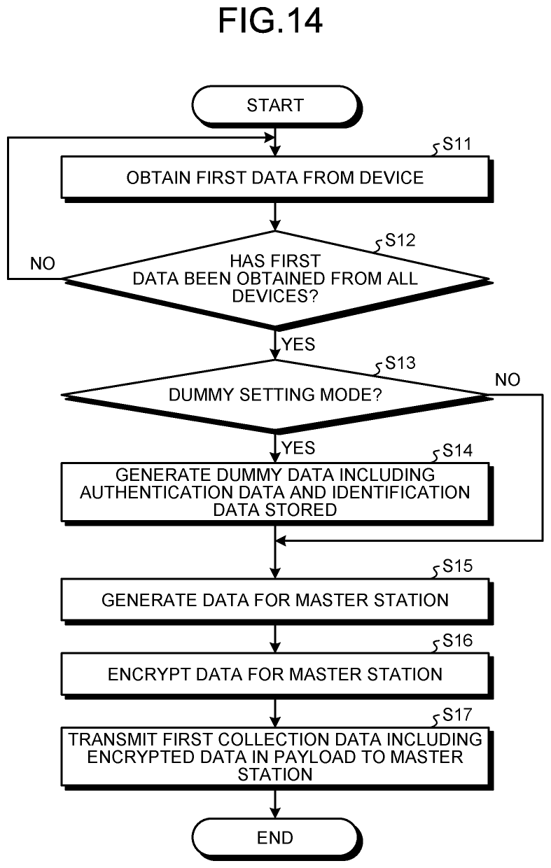

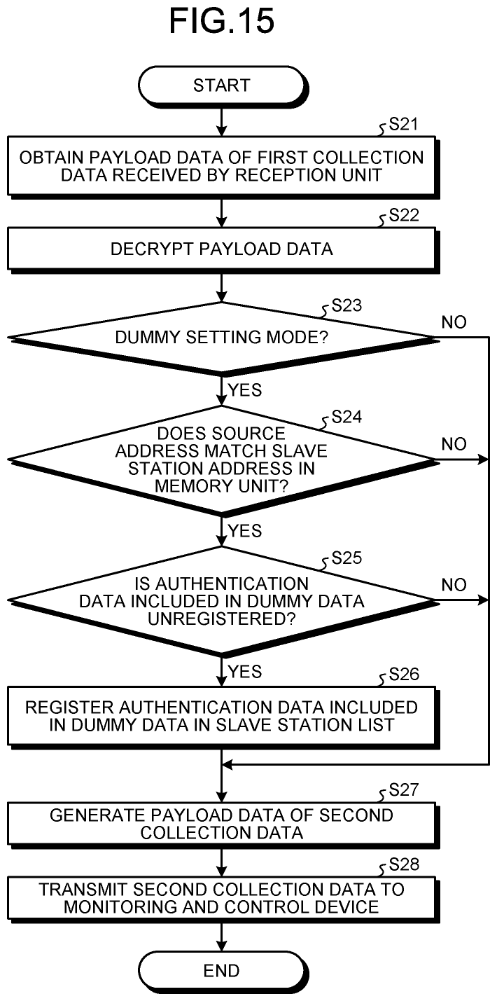

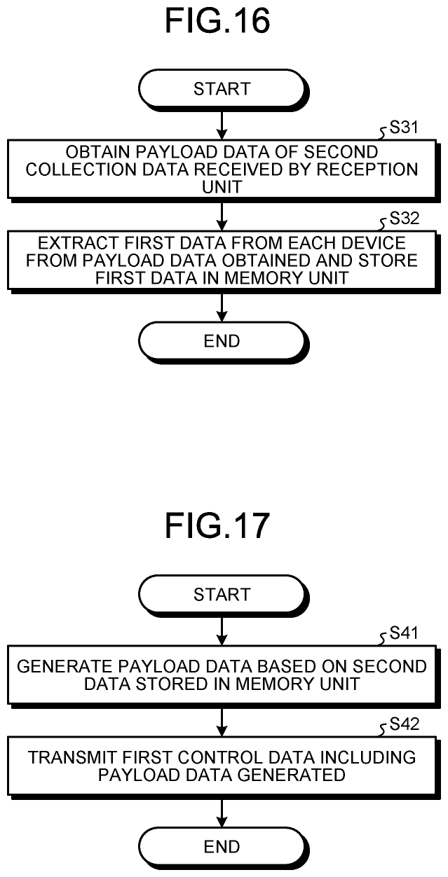

A data collection process of the monitoring and control system 100 will next be described using a flowchart. FIG. 14 is a flowchart illustrating an example of data collection process of the slave station according to the first embodiment. FIG. 15 is a flowchart illustrating an example of data collection process of the master station according to the first embodiment. FIG. 16 is a flowchart illustrating an example of data collection process of the monitoring and control device according to the first embodiment.

As illustrated in FIG. 14, the control unit 27 of the slave station 2 obtains the first data from the device 1 via the communication unit 23 (step S11). The control unit 27 determines whether the first data has been obtained from all the devices 1 communicably connected thereto via the communication unit 23 (step S12). If it is determined that the first data has not yet been obtained from all the devices 1 (step S12: No), the control unit 27 causes the process to return to step S11.

If it is determined that the first data has been obtained from all the devices 1 (step S12: Yes), the control unit 27 determines whether the operation mode is set to dummy setting mode (step S13). If it is determined that the operation mode is set to dummy setting mode (step S13: Yes), the control unit 27 generates dummy data including the authentication data and the identification data stored in the memory unit 26 (step S14). Note that the identification data to be included in the dummy data is the slave station ID described above.

If it is determined that the operation mode is not set to dummy setting mode (step S13: No) or when the operation at step S14 is complete, the control unit 27 generates data for the master station 3 (step S15). In the operation at step S15, the control unit 27 generates payload data based on the area assignment table 50.

The control unit 27 encrypts the data for the master station 3 (step S16). The data for the master station 3 encrypted is output to the transmission unit 22 by the control unit 27, which in turn causes the transmission unit 22 to transmit the first collection data including the encrypted data in the payload thereof to the master station 3 (step S17), and the process illustrated in FIG. 14 is then terminated.

The first collection data transmitted from the slave station 2 is received by the reception unit 34 of the master station 3. As illustrated in FIG. 15, the control unit 37 of the master station 3 obtains the payload data of the first collection data received by the reception unit 34 (step S21). Then, the control unit 37 decrypts the payload data obtained at step S21 using the key data contained in the slave station list 61 (step S22).

Then, the control unit 37 determines whether the operation mode is set to dummy setting mode (step S23). If it is determined that the operation mode is set to dummy setting mode (step S23: Yes), the control unit 37 determines whether the source address in the first collection data received by the reception unit 34 matches the slave station address in the memory unit 36 (step S24).

In the operation at step S24, the control unit 37 obtains, from the slave station list 61, the slave station address associated with the slave station ID included in the dummy data decrypted at step S22. Then, the control unit 37 determines whether the source address obtained from the reception unit 34 matches the slave station address obtained from the slave station list 61.

If it is determined that the source address matches the slave station address in the memory unit 36 (step S24: Yes), the control unit 37 determines whether the authentication data included in the dummy data decrypted at step S22 is unregistered in the slave station list 61 (step S25).

For example, assume that the authentication data is not associated, in the slave station list 61, with the slave station ID included in the dummy data. In this case, the control unit 37 determines, at step S25, that the authentication data is unregistered in the slave station list 61. If it is determined that the authentication data is unregistered in the slave station list 61 (step S25: Yes), the control unit 37 registers the authentication data included in the dummy data in the slave station list 61 (step S26).

If it is determined that the operation mode is not set to dummy setting mode (step S23: No), if it is determined that the source address does not match the slave station address in the memory unit 36 (step S24: No), if it is determined that the authentication data is not unregistered in the slave station list 61 (step S25: No), or when the operation at step S26 is complete, the control unit 37 generates payload data of the second collection data (step S27). Then, the control unit 37 transmits the second collection data to the monitoring and control device (step S28), and terminates the process illustrated in FIG. 15. Note that if it is determined that the source address matches the slave station address in the memory unit 36 (step S24: Yes), the control unit 37 may skip the operation at step S25, and rather perform the operation at step S26.

The payload data generated by the control unit 37 is output to the transmission unit 32, which in turn causes the transmission unit 32 to transmit, to the monitoring and control device 4, the second collection data including, in the payload thereof, the first data from the devices 1₁ to 1ₘ included in the first collection data.

The second collection data transmitted from the master station 3 is received by the reception unit 41 of the monitoring and control device 4. As illustrated in FIG. 16, the control unit 44 of the monitoring and control device 4 obtains the payload data of the second collection data received by the reception unit 41 (step S31). Then, the control unit 44 extracts the first data from each of the devices 1 from the payload data obtained, stores the first data in the memory unit 43 (step S32), and terminates the process illustrated in FIG. 16.

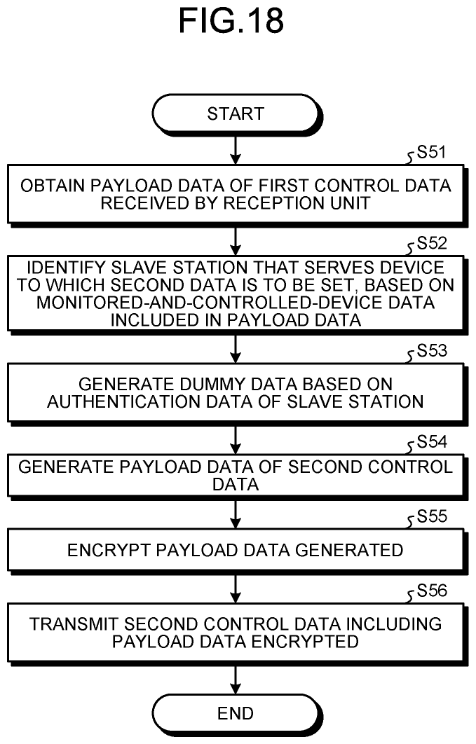

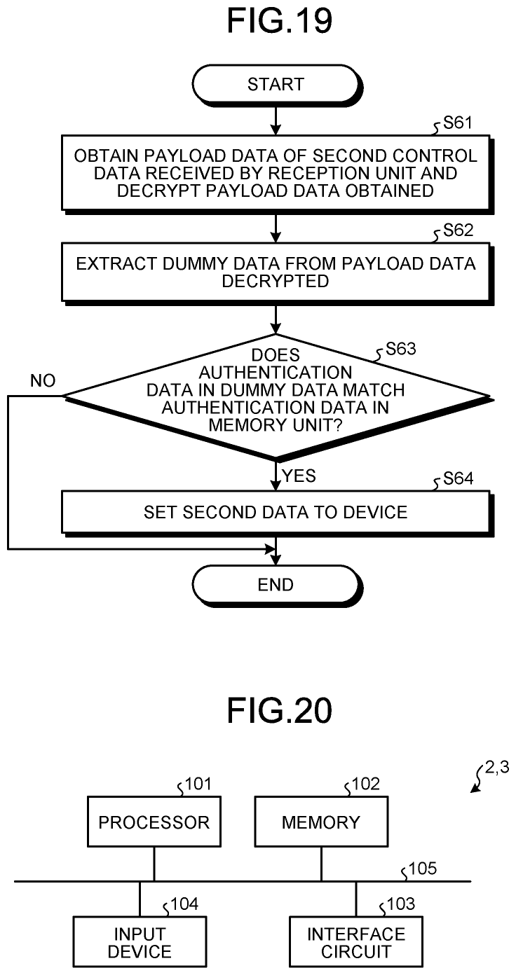

A data setting process of the monitoring and control system 100 will next be described using a flowchart. FIG. 17 is a flowchart illustrating an example of data setting process of the monitoring and control device according to the first embodiment. FIG. 18 is a flowchart illustrating an example of data setting process of the master station according to the first embodiment. FIG. 19 is a flowchart illustrating an example of data setting process of the slave station according to the first embodiment.

As illustrated in FIG. 17, the control unit 44 of the monitoring and control device 4 generates payload data of the first control data based on the second data stored in the memory unit 43 (step S41). The payload data generated by the control unit 44 at step S41 is output to the transmission unit 42, which in turn causes the transmission unit 42 to transmit the first control data including the payload data generated by the control unit 44 to the master station 3 (step S42), and the process illustrated in FIG. 17 is then terminated.

The first control data transmitted from the monitoring and control device 4 is received by the reception unit 31 of the master station 3. The control unit 37 of the master station 3 obtains, from the reception unit 31, the payload data of the first control data received by the reception unit 31 (step S51). Then, the control unit 37 identifies the slave station 2 serving the devices 1 in which the second data is to be set, based on the monitored-and-controlled-device data included in the payload data (step S52).

The control unit 37 obtains the authentication data of the slave station 2 identified at step S52 from the slave station list 61 stored in the memory unit 36, and generates dummy data based on the obtained authentication data of the slave station 2 (step S53). Then, the control unit 37 generates payload data of the second control data including the second data for the devices 1₁ to 1ₘ and the dummy data arranged based on the area assignment table 62 (step S54), and encrypts the payload data generated (step S55). The payload data encrypted is output to the transmission unit 35 by the control unit 37, which in turn causes the transmission unit 35 to transmit, to the slave station 2, the second control data including the payload data encrypted by the control unit 37 (step S56), and the process illustrated in FIG. 18 is then terminated.

The second control data transmitted from the master station 3 is received by the reception unit 21 of the slave station 2. The control unit 27 of the slave station 2 obtains, from the reception unit 21, the payload data of the second control data received by the reception unit 21, and decrypts the payload data obtained (step S61). The control unit 27 extracts the dummy data from the decrypted payload data based on the area assignment table 50 (step S62). Note that the control unit 27 also obtains the source address in the second control data from the reception unit 21.

Then, the control unit 27 determines whether the authentication data included in the dummy data extracted at step S62 matches the authentication data stored in the memory unit 26 (step S63). If it is determined that the authentication data included in the dummy data matches the authentication data stored in the memory unit 26 (step S63: Yes), the control unit 27 transmits each piece of the second data included in the data set in the second control data to the corresponding device 1 of the multiple devices 1₁ to 1ₘ to cause the second data to be set in each of the devices 1 (step S64).

When the operation at step S64 is complete or if it is determined that the authentication data in the dummy data does not match the authentication data stored in the memory unit 26 (step S63: No), the control unit 27 terminates the process illustrated in FIG. 19.

FIG. 20 is a diagram illustrating an example of hardware configuration of the slave station and of the master station according to the first embodiment. As illustrated in FIG. 20, the slave station 2 and the master station 3 each include a computer including a processor 101, a memory 102, an interface circuit 103, and an input device 104.

The processor 101, the memory 102, the interface circuit 103, and the input device 104 can exchange data with one another over a bus 105. The processor 101 is an example of processing circuitry, and includes one or more of a central processing unit (CPU), a digital signal processor (DSP), and a system large scale integration (LSI). The memory 102 includes one or more of a random access memory (RAM), a read-only memory (ROM), a flash memory, and an enable program read-only memory (EPROM).

In addition, the memory 102 includes a recording medium that records therein a computer-readable program. Such recording medium includes one or more of a non-volatile or volatile semiconductor memory, a magnetic disk, a flexible memory, an optical disk, a compact disc, and a digital versatile disc (DVD). Note that each of the slave station 2 and the master station 3 may include an integrated circuit such as an application specific integrated circuit (ASIC) and a field programmable gate array (FPGA).

In the slave station 2, the communication units 20 and 23 are each implemented in the interface circuit 103; the input unit 28 is implemented in the input device 104; and the memory unit 26 is implemented in the memory 102. In addition, in the slave station 2, the processor 101 reads and executes a program stored in the memory 102 to perform the functionality of the data acquisition unit 51, the data generation unit 52, the data output unit 53, the collection unit 54, the authentication unit 55, the cryptographic processing unit 56, and the editing unit 57.

In the master station 3, the communication units 30 and 33 are each implemented in the interface circuit 103; the input unit 38 is implemented in the input device 104; and the memory unit 36 is implemented in the memory 102. In addition, in the master station 3, the processor 101 reads and executes a program stored in the memory 102 to perform the functionality of the data acquisition unit 71, the data generation unit 72, the data output unit 73, the cryptographic processing unit 74, and the editing unit 75.

Moreover, elements including the communication unit 40, the memory unit 43, the control unit 44, and the input unit 46 in the monitoring and control device 4 are configured similarly to the hardware configuration illustrated in FIG. 20. The communication unit 40 is implemented in the interface circuit 103. The input unit 46 is implemented in the input device 104. The memory unit 43 is implemented in the memory 102. In addition, in the monitoring and control device 4, the processor 101 reads and executes a program stored in the memory 102 to perform the functionality of the data acquisition unit 91, the display control unit 92, the data generation unit 93, and the data output unit 94.

As described above, the monitoring and control system 100 according to the first embodiment includes the slave station 2 that obtains first data from each of the multiple devices 1, the master station 3, and the monitoring and control device 4 that collects the first data from the slave station 2 via the master station 3, and transmits second data for controlling the devices 1 to the slave station 2 via the master station 3. The master station 3 includes the memory unit 36 that stores authentication data, the reception unit 31 that receives first control data including the second data from the monitoring and control device 4, and the transmission unit 35 that transmits, to the slave station 2, second control data including the authentication data stored in the memory unit 36 and the second data. The transmission unit 35 transmits, to the slave station 2, the second control data including the authentication data stored in an area in a payload defined to store the second data. The slave station 2 includes the memory unit 26 that stores authentication data, the reception unit 21 that receives the second control data from the master station 3, the authentication unit 55 that determines whether data included in the area in the payload of the second control data received by the reception unit 21 matches the authentication data stored in the memory unit 26, and the transmission unit 25 that, if the authentication unit 55 determines that the data included in the area in the payload matches the authentication data stored in the memory unit 26, transmits the second data included in the second control data to the device(s) 1. This can reduce or eliminate the effect on the system configuration in the monitoring and control system 100, and can also prevent unauthorized control.

In addition, the payload of the second control data includes the multiple data areas AR₁ to ARₙ defined to respectively store pieces of the second data for the multiple respective devices 1₁ to 1ₘ. The transmission unit 35 transmits the second control data storing the second data in areas other than one area of the multiple areas AR₁ to ARₙ, and storing the authentication data in the one area. The authentication unit 55 determines whether data included in the one area in the payload of the second control data received by the reception unit 21 matches the authentication data stored in the memory unit 26. If the authentication unit 55 determines that the data included in the one area matches the authentication data stored in the memory unit 26, the transmission unit 25 transmits the second data included in the second control data to the device(s) 1. This can further reduce or eliminate the effect on the system configuration in the monitoring and control system 100, and can also prevent unauthorized control.

In addition, the monitoring and control system 100 includes a plurality of the slave station 2. The authentication data is authentication data different between the slave stations 2. The transmission unit 35 reads, from the memory unit 36, authentication data of one of the slave stations 2 that is the destination of the second control data, and transmits the second control data including the authentication data read and the second data to the one of the slave stations 2. Thus, use of authentication data different between the slave stations 2 can further enhance authentication performed by each of the slave stations 2.

In addition, the monitoring and control system 100 includes editing units 57 and 75 that edit the authentication data. This enables the authentication data to be readily added or deleted when a slave station 2 is added or deleted after the monitoring and control system 100 is placed into operation.

Each of the multiple slave stations 2 includes the collection unit 54 that collects the first data transmitted from each of the multiple devices 1, and the transmission unit 22 that transmits, to the master station 3, first collection data including the first data collected by the collection unit 54 and the authentication data stored in the memory unit 26. The transmission unit 22 transmits, to the master station 3, the first collection data including the first data stored in an area in a payload defined to store the first data. The master station 3 includes the reception unit 34 that receives the first collection data transmitted from each of the slave stations 2, and the data acquisition unit 71 that obtains the authentication data from the area in the payload included in the first collection data received by the reception unit 34, and stores the authentication data obtained, in the memory unit 36. This eliminates the need to register the authentication data of the slave stations 2 in advance in the master station 3. In addition, inclusion of the authentication data in the first collection data by the slave stations 2 allows the authentication data to be periodically updated.

In addition, the memory unit 36 stores the slave station address of the slave station 2. The data acquisition unit 71 stores, in the memory unit 36, the authentication data included in the dummy data of the first collection data in a case in which the source address included in the first collection data matches the slave station address stored in the memory unit 36. This can prevent unauthorized setting of authentication data in the master station 3.

Moreover, the master station 3 includes the cryptographic processing unit 74 that encrypts data in the payload of the second control data generated by the data generation unit 72. The transmission unit 35 transmits, to the slave station 2, the second control data including data in the payload encrypted by the cryptographic processing unit 74. The slave station 2 includes the cryptographic processing unit 56 that decrypts the data in the payload of the second control data encrypted. This can provide further enhancement of authentication.

### Second Embodiment

In the first embodiment, authentication processing is performed based on authentication data unique to each slave station. A second embodiment differs from the first embodiment in performing authentication processing based on authentication data unique to each master station. In the following description, like reference characters designate elements having functionality similar to the functionality in the first embodiment, and a description thereof will be omitted. Differences from the monitoring and control system 100 according to the first embodiment will be primarily described.

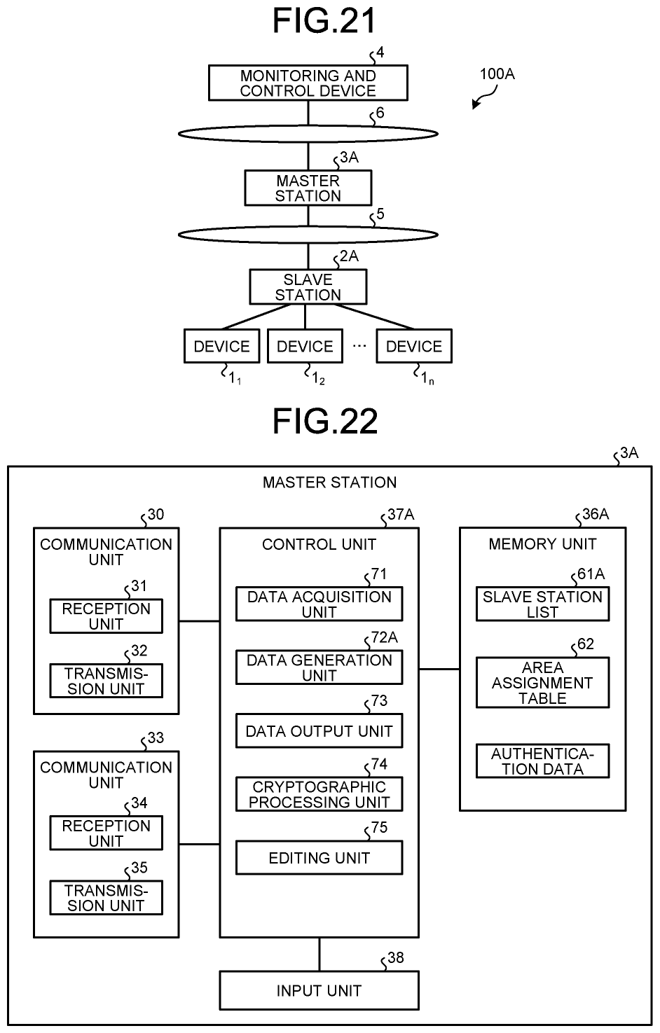

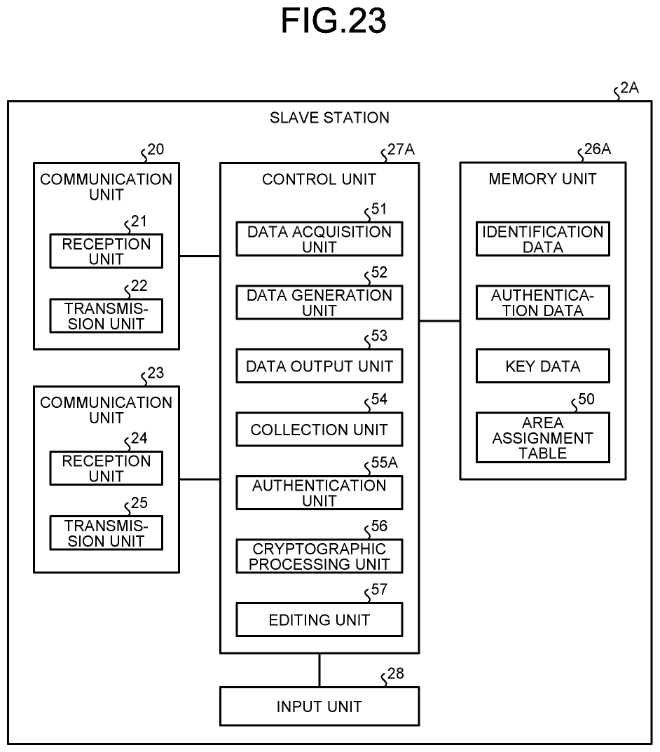

FIG. 21 is a diagram illustrating an example configuration of a monitoring and control system according to the second embodiment. FIG. 22 is a diagram illustrating an example configuration of the master station according to the second embodiment. FIG. 23 is a diagram illustrating an example configuration of the slave station according to the second embodiment.

As illustrated in FIG. 21, a monitoring and control system 100A according to the second embodiment includes a slave station 2A, a master station 3A, and the monitoring and control device 4. Note that, for convenience of illustration, the example illustrated in FIG. 21 illustrates one slave station 2A and one master station 3A, but in a similar manner to the monitoring and control system 100, the monitoring and control system 100A includes multiple slave stations 2A and multiple master stations 3A. Note that the slave station 2A and the master station 3A differ from the slave station 2 and the master station 3 according to the first embodiment in that the operation mode has no dummy setting mode, but the operation mode is non-dummy setting mode.

The master station 3A includes, as illustrated in FIG. 22, the communication units 30 and 33, a memory unit 36A, a control unit 37A, and the input unit 38. The memory unit 36A stores a slave station list 61A, the area assignment table 62, and authentication data unique to each one of the master stations 3A. The slave station list 61A differs from the slave station list 61 in not including authentication data.

The control unit 37A differs from the control unit 37 according to the first embodiment in including a data generation unit 72A in place of the data generation unit 72. The data generation unit 72A differs from the data generation unit 72 in including authentication data unique to each master station 3A in dummy data unique to each slave station 2A. The transmission unit 35 transmits, to the slave station 2A, second control data including, in the payload thereof, dummy data including the slave station ID as well as the authentication data unique to each master station 3A.

The slave station 2A includes the communication units 20 and 23, a memory unit 26A, a control unit 27A, and the input unit 28. The memory unit 26A differs from the memory unit 26 in storing authentication data unique to each master station 3A in place of dummy data unique to each slave station 2A.

The control unit 27A differs from the control unit 27 according to the first embodiment in including an authentication unit 55A in place of the authentication unit 55. The authentication unit 55A determines whether the authentication data included in the dummy data matches the authentication data unique to each master station 3A stored in the memory unit 26A. If the authentication unit 55A determines that the authentication data included in the dummy data matches the authentication data stored in the memory unit 26A, the data output unit 53 outputs, to the transmission unit 25, the second data for the devices 1₁ to 1ₘ extracted from the payload data of the second control data.

As described above, the monitoring and control system 100A according to the second embodiment is configured such that the slave station 2A and the master station 3A each store authentication data unique to each master station 3A. The master station 3A then transmits, to the slave station 2A, second control data including, in the payload thereof, dummy data including the authentication data unique to each master station 3A. The slave station 2A provides authentication based on the dummy data included in the second control data. This eliminates the need to prepare and store authentication data for each of the slave stations 2A, thereby enabling, for example, processing load of the master station 3A to be reduced.

An example hardware configuration of each of the slave station 2A and the master station 3A according to the second embodiment is the same as the hardware configuration of the slave station 2 and of the master station 3 illustrated in FIG. 20. The processor 101 reads and executes a program stored in the memory 102 to perform the functionality of the control units 27A and 37A.

As described above, the monitoring and control system 100A according to the second embodiment includes multiple slave stations 2A, and the authentication data used between the master station 3A and each of the slave stations 2A is authentication data common to the slave stations 2A. This can enhance prevention of unauthorized control.

### Third Embodiment

The master station generates the dummy data in the second embodiment, but a third embodiment differs from the first embodiment in that the monitoring and control device 4 generates the dummy data. In the following description, like reference characters designate elements having functionality similar to the functionality in the first embodiment, and a description thereof will be omitted. Differences from the monitoring and control system 100 according to the first embodiment will be primarily described.

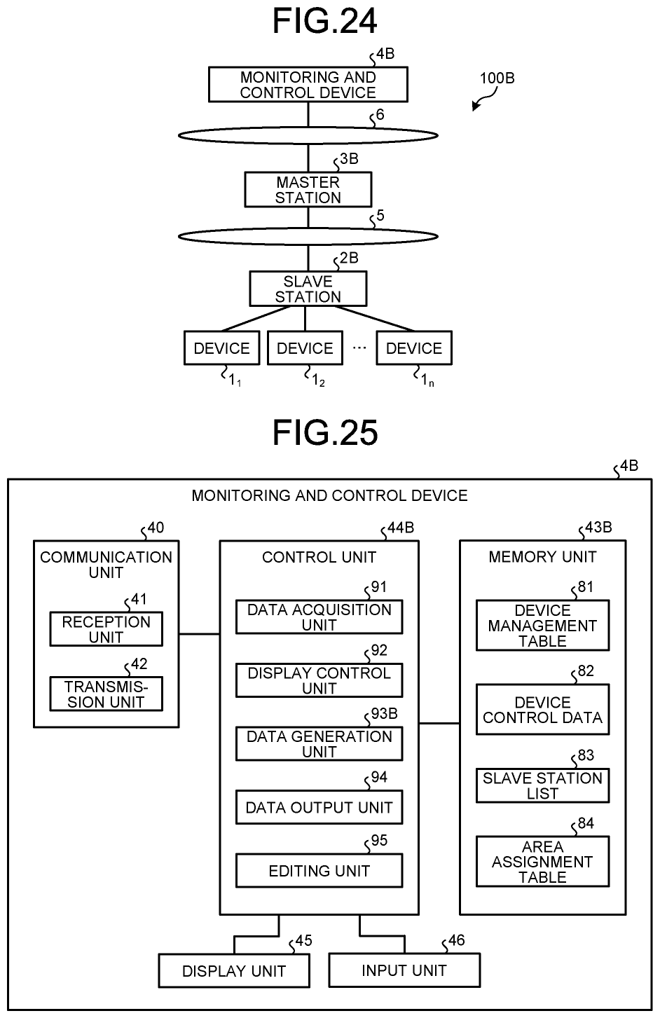

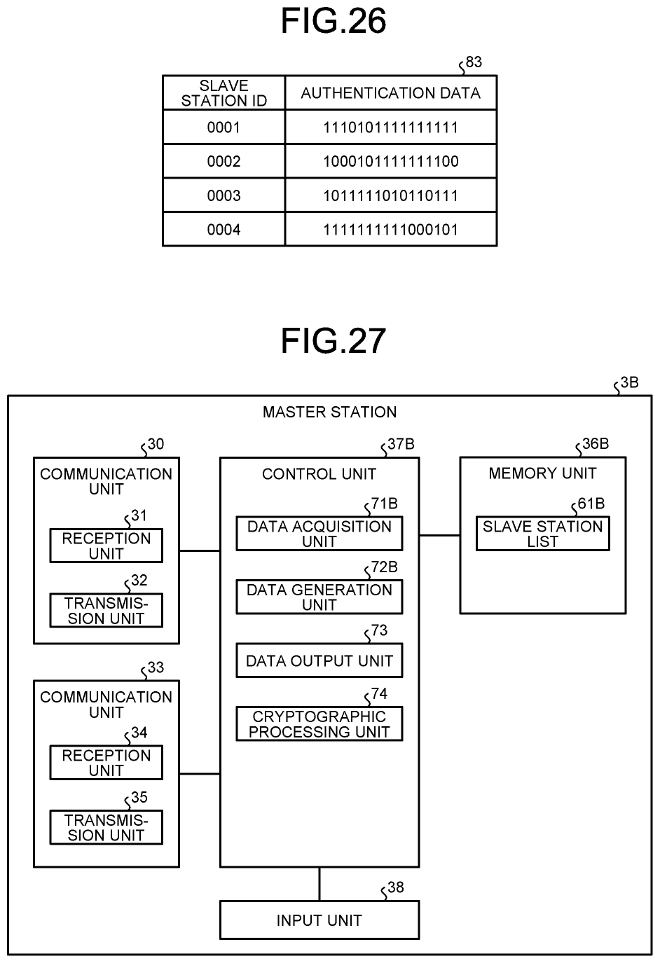

FIG. 24 is a diagram illustrating an example configuration of a monitoring and control system according to the third embodiment. FIG. 25 is a diagram illustrating an example configuration of the monitoring and control device according to the third embodiment. FIG. 26 is a diagram illustrating an example structure of a slave station list according to the third embodiment. FIG. 27 is a diagram illustrating an example configuration of the master station according to the third embodiment.

As illustrated in FIG. 24, a monitoring and control system 100B according to the third embodiment includes a slave station 2B, a master station 3B, and a monitoring and control device 4B. Note that, for convenience of illustration, the example illustrated in FIG. 24 illustrates one slave station 2B and one master station 3B, but in a similar manner to the monitoring and control system 100, the monitoring and control system 100B includes multiple slave stations 2B and multiple master stations 3B.

Note that the slave station 2B and the master station 3B differ from the slave station 2 and the master station 3 according to the first embodiment in that the operation mode has no dummy setting mode, but the operation mode is non-dummy setting mode. The slave station 2B according to the third embodiment is similar to the slave station 2 according to the first embodiment except that the operation mode has no dummy setting mode. The following description will therefore omit description of the slave station 2B.

The monitoring and control device 4B includes, as illustrated in FIG. 25, the communication unit 40, a memory unit 43B, a control unit 44B, the display unit 45, and the input unit 46. The memory unit 43B is an example of a first memory unit, and the transmission unit 42 of the communication unit 40 is an example of a first transmission unit.

The memory unit 43B differs from the memory unit 43 in further storing a slave station list 83 and an area assignment table 84. The slave station list 83 includes, as illustrated in FIG. 26, information including “slave station ID” and “authentication data” associated with each other. “Slave station ID” is identification data of a slave station 2B. “Authentication data” is authentication data unique to each of the slave stations 2B. The area assignment table 84 is the same as the area assignment table 50.

The control unit 44B differs from the control unit 44 in including a data generation unit 93B in place of the data generation unit 93, and in further including an editing unit 95. The data generation unit 93B obtains, from the slave station list 83, authentication data associated with the slave station ID of the slave station 2B that is the destination of the second data. The data generation unit 93B generates dummy data including the slave station ID of the slave station 2B that is the destination of the second data, and the authentication data obtained from the slave station list 83.

The control unit 44B then generates payload data including a data set storing, in order, the dummy data generated and the second data for the devices 1₁ to 1ₘ obtained from the memory unit 43B, and the monitored-and-controlled-device data described above, based on the area assignment table 84. The monitored-and-controlled-device data includes data that specifies the dummy data in the payload data, in addition to the data that associates each piece of the second data in the payload data with the corresponding device ID.

For example, assuming that the area assignment table 84 is the same as the area assignment table 62 illustrated in FIG. 10, the dummy data is stored, for example, in the data area AS₁ of the data areas AS₁ to ASₙ in the payload illustrated in FIG. 6, and the second data for the devices 1₁ to 1ₘ are stored in the data areas AS₂ to ASₙ in order of the devices 1₁ to 1ₘ.

The data output unit 94 outputs the payload data generated by the data generation unit 93B to the communication unit 40. The transmission unit 42 of the communication unit 40 transmits, to the master station 3B, the first control data, which is a data packet containing the monitored-and-controlled-device data and the data set described above output from the data output unit 94, via the communication network 6.

The editing unit 95 edits authentication data based on an input to the input unit 46. This allows the authentication data to be configured and updated. The editing unit 95 is also capable of editing the area assignment table 84 based on an input to the input unit 46. This allows the type of data to be arbitrarily set for each of the data areas AR.

The master station 3B includes, as illustrated in FIG. 27, the communication units 30 and 33, a memory unit 36B, a control unit 37B, and the input unit 38. The memory unit 36B differs from the memory unit 36 in storing a slave station list 61B in place of the slave station list 61, and in not storing the area assignment table 62. In a similar manner to the slave station list 61A, the slave station list 61B does not include authentication data.

The control unit 37B includes a data acquisition unit 71B, a data generation unit 72B, the data output unit 73, and the cryptographic processing unit 74. The data acquisition unit 71B obtains the payload data of the first control data from the reception unit 31. Upon obtaining the payload data of the first control data, the data acquisition unit 71B obtains the second data for the devices 1₁ to 1ₘ and the dummy data from the payload data of the first control data, based on the monitored-and-controlled-device data.

The data generation unit 72B generates payload data including the second data for the devices 1₁ to 1ₘ and the dummy data obtained by the data acquisition unit 71B. By way of example, the data generation unit 72B can generate payload data by using the second data for the devices 1₁ to 1ₘ and the dummy data just as included in the payload data of the first control data.

For example, assume that the data area AS₁ stores the dummy data, and the data areas AS₂ to ASₙ store the second data for the devices 1₁ to 1ₘ in order of the devices 1₁ to 1ₘ, of the data areas AS₁ to ASₙ in the payload of the first control data. In this case, the data generation unit 72B stores the dummy data in the data area AR₁, and stores the second data for the devices 1₁ to 1ₘ in the data areas AR₂ to ARₙ in order of the devices 1₁ to 1ₘ, of the data areas AR₁ to ARₙ in the payload illustrated in FIG. 8.

The memory unit 36B can also store the area assignment table 62. In this case, the data generation unit 72B can generate payload data including the second data for the devices 1₁ to 1ₘ and the dummy data based on the area assignment table 62.

The cryptographic processing unit 74 encrypts the payload data generated by the data generation unit 72B based on the slave station list 61B. The data output unit 73 outputs the payload data encrypted by the cryptographic processing unit 74 to the transmission unit 35. The transmission unit 35 transmits, to the slave station 2B, the second control data, which is a data packet containing the payload data output from the data output unit 73 in the payload, via the communication network 5.

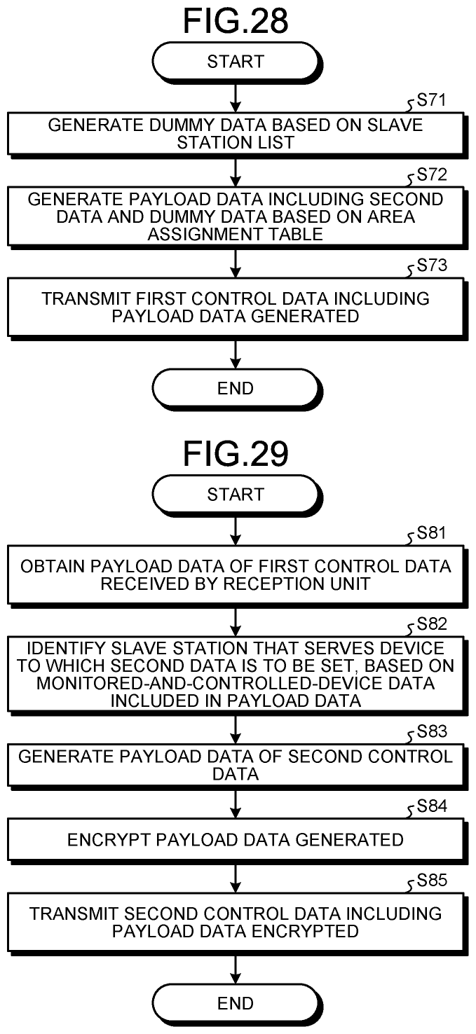

A data setting process of the monitoring and control system 100B will next be described using a flowchart. FIG. 28 is a flowchart illustrating an example of data setting process of the monitoring and control device according to the third embodiment. FIG. 29 is a flowchart illustrating an example of data setting process of the master station according to the third embodiment.

As illustrated in FIG. 28, the control unit 44B of the monitoring and control device 4B generates dummy data based on the slave station list 83 stored in the memory unit 43B (step S71). Then, the control unit 44B generates payload data including the second data for the devices 1₁ to 1ₘ and the dummy data, based on the area assignment table 84 stored in the memory unit 43B (step S72). The payload data generated by the control unit 44B at step S72 is output to the transmission unit 42, which in turn causes the transmission unit 42 to transmit the first control data including the payload data generated by the control unit 44B to the master station 3B (step S73), and the process illustrated in FIG. 28 is then terminated.

The first control data transmitted from the monitoring and control device 4B is received by the reception unit 31 of the master station 3B. The control unit 37B of the master station 3B obtains, from the reception unit 31, the payload data of the first control data received by the reception unit 31 (step S81). Then, the control unit 37B identifies the slave station 2B serving the devices 1 in which the second data is to be set, based on the monitored-and-controlled-device data included in the payload data (step S82).

The control unit 37B generates payload data of the second control data addressed to the slave station 2B identified at step S82 (step S83), and encrypts the payload data generated (step S84). The payload data encrypted is output to the transmission unit 35 by the control unit 37B, which in turn causes the transmission unit 35 to transmit the second control data including the payload data encrypted by the control unit 37B to the slave station 2B (step S85), and the process illustrated in FIG. 29 is then terminated.

An example hardware configuration of the master station 3B according to the third embodiment is the same as the hardware configuration of the master station 3 illustrated in FIG. 20. The processor 101 reads and executes a program stored in the memory 102 to perform the functionality of the control unit 37B. In addition, in a similar manner to the monitoring and control device 4, elements including the communication unit 40, the memory unit 43B, the control unit 44B, and the input unit 46 in the monitoring and control device 4B are also configured similarly to the hardware configuration illustrated in FIG. 20. In the monitoring and control device 4B, the processor 101 reads and executes a program stored in the memory 102 to perform the functionality of the data acquisition unit 91, the display control unit 92, the data generation unit 93B, the data output unit 94, and the editing unit 95.

As described above, the monitoring and control system 100B according to the third embodiment includes the slave station 2B that obtains first data from each of the multiple devices 1, the master station 3B, and the monitoring and control device 4B that collects the first data from the slave station 2B via the master station 3B, and transmits second data for controlling the devices 1 to the slave station 2B via the master station 3B. The monitoring and control device 4B includes the memory unit 43B that stores authentication data, and the transmission unit 42 that transmits, to the master station 3B, first control data including the authentication data stored in the memory unit 43B and the second data. The transmission unit 42 transmits, to the master station 3, the first control data including the authentication data stored in an area in a payload defined to store the second data. The master station 3B transmits, to the slave station 2B, second control data including, in a payload, data in the payload of the first control data upon reception of the first control data from the monitoring and control device 4B. The slave station 2B includes the memory unit 26 that stores authentication data, the reception unit 21 that receives the second control data from the master station 3B, the authentication unit 55 that determines whether data included in the area in the payload of the second control data received by the reception unit 21 matches the authentication data stored in the memory unit 26, and the transmission unit 25 that, if the authentication unit 55 determines that the data included in the area in the payload matches the authentication data stored in the memory unit 26, transmits the second data included in the second control data to the device(s) 1. This can reduce or eliminate the effect on the system configuration in the monitoring and control system 100B, and can also prevent unauthorized control.

Note that the monitoring and control system 100B according to the third embodiment can also perform authentication processing based on authentication data unique to the monitoring and control device 4B similarly to the monitoring and control system 100A in the second embodiment instead of performing authentication processing based on the authentication data unique to each slave station 2B. In this case, the memory unit 43B of the monitoring and control device 4B stores authentication data unique to the monitoring and control device 4B in place of the slave station list 83, and the memory unit 26 of the slave station 2B also stores the authentication data unique to the monitoring and control device 4B. Then, the authentication data unique to the monitoring and control device 4B is transmitted and received between the monitoring and control device 4B and the slave station 2B.

In addition, the area assignment table 62 may be provided in each of the slave stations 2 and 2A in the first and second embodiments, and the area assignment table 84 may be provided in each of the slave stations 2B in the third embodiment.

The configurations described in the foregoing embodiments are merely examples of various aspects of the present invention. These configurations may be combined with a known other technology, and moreover, a part of such configurations may be omitted and/or modified without departing from the spirit of the present invention.

### REFERENCE SIGNS LIST

1, 1₁-1ₘ device; 2, 2₁-2₄, 2A, 2B slave station; 3, 3₁, 3₂, 3A, 3B master station; 4, 4B monitoring and control device; 5, 6 communication network; 8, 8₁, 8₂ facility; 9, 9₁-9₄ area; 20, 23, 30, 33, 40 communication unit; 21, 24, 31, 34, 41 reception unit; 22, 25, 32, 35, transmission unit; 26, 26A, 36, 36A, 36B, 43, 43B memory unit; 27, 27A, 37, 37A, 37B, 44, 44B control unit; 28, 38, 46 input unit; 45 display unit; 50, 62, 84 area assignment table; 51, 71, 71B, 91 data acquisition unit; 52, 72, 72A, 72B, 93, 93B data generation unit; 53, 73, 94 data output unit; 54 collection unit; 55, 55A authentication unit; 56, 74 cryptographic processing unit; 57, 75, 95 editing unit; 61, 61A, 61B, 83 slave station list; 81 device management table; 82 device control data; display control unit; 100, 100A, 100B monitoring and control system; AR, AR₁-ARₙ, AS, AS₁-ASₙ data area.

1. A monitoring and control system comprising:
a slave station to obtain first data from each of a plurality of devices, a master station, and a monitoring and control device to collect the first data of each of the plurality of devices from the slave station via the master station and to transmit a plurality of pieces of second data each for controlling a corresponding device of the plurality of devices to the slave station via the master station, wherein
the master station includes
a first memory to store authentication data,
a first receiver to receive first control data including the plurality of pieces of second data from the monitoring and control device, and
a first transmitter to transmit, to the slave station, second control data including the authentication data stored in the first memory and the plurality of pieces of second data,
the first transmitter
transmits, to the slave station, the second control data including the authentication data stored in an area that stores none of the plurality of pieces of second data, of a plurality of areas in a payload defined to store the second data, and
the slave station includes
a second memory to store area assignment information indicating in which area of the plurality of areas in the payload each of the plurality of pieces of second data and of the authentication data is stored, and to store authentication data,
a second receiver to receive the second control data from the master station,
an authentication determiner to determine whether data included in an area indicated by the area assignment information as an area to store the authentication data, of the plurality of areas in the payload of the second control data received by the second receiver, matches the authentication data stored in the second memory,
a second transmitter to, if the authentication determiner determines that the data included in the area in the payload matches the authentication data stored in the second memory, transmit each of the plurality of pieces of second data included in the second control data to a corresponding device of the plurality of devices,
an editor to edit information indicating the area to store the authentication data in the area assignment information, and
a third transmitter to transmit, to the master station, the information indicating the area to store the authentication data, edited by the editor.

2. (canceled)

3. The monitoring and control system according to claim 1, wherein
the payload includes
a plurality of areas each defined to store a corresponding piece of the plurality of pieces of second data,
the first transmitter
transmits the second control data storing the plurality of pieces of second data in an area other than one area of the plurality of areas, and storing the authentication data in the one area,
the authentication determiner
determines whether data included in the one area in the payload of the second control data received by the second receiver matches the authentication data stored in the second memory, and
if the authentication determiner determines that the data included in the one area matches the authentication data stored in the second memory, the second transmitter transmits each of the plurality of pieces of second data included in the second control data to a corresponding device of the plurality of devices.

4. The monitoring and control system according to claim 1, comprising:
a plurality of the slave stations, wherein
the authentication data is authentication data different between the slave stations, and
the first transmitter reads, from the first memory, authentication data of one of the slave stations that is a destination of the second control data, and transmits the second control data including the authentication data read and the second data to the one of the slave stations.

5. The monitoring and control system according to claim 1, comprising:
a plurality of the slave stations, wherein
the authentication data is authentication data common to the slave stations.

6. The monitoring and control system according to claim 1, wherein:
the editor edits the authentication data.

7. The monitoring and control system according to claim 1, wherein
the master station includes
a first cryptographic processor to encrypt data in the payload of the second control data,
the first transmitter
transmits, to the slave station, the second control data including the data in the payload encrypted by the first cryptographic processor, and
the slave station includes
a second cryptographic processor to decrypt the data in the payload of the second control data encrypted.

8. The monitoring and control system according to claim 1, wherein
the slave station includes
a collector to collect the first data transmitted from each of the plurality of devices, and
the third transmitter transmits, to the master station, collection data including the first data collected by the collector and the authentication data stored in the second memory
and including the first data, collected by the collector, stored in an area in a payload defined to store the first data, and
the master station includes
a third receiver to receive the collection data transmitted from the slave station, and
a data obtainer to obtain the authentication data from the area in the payload included in the collection data received by the third receiver, and to store the authentication data obtained, in the first memory.

9. The monitoring and control system according to claim 8, wherein
the first memory
stores an address of the slave station, and
the data obtainer
stores, in the first memory, the authentication data included in the area in the payload of the collection data in a case in which a source address included in the collection data matches the address stored in the first memory.

10. The monitoring and control system according to claim 8, wherein
the slave station includes
a second cryptographic processor to encrypt data in the payload of the collection data,
the third transmitter
transmits, to the master station, the collection data including the data in the payload encrypted by the second cryptographic processor, and
the master station includes
a first cryptographic processor to decrypt the data in the payload of the collection data.
